(19) United States
(12) Patent Application Publication
(10) Pub. No.: US 2026/0309931 A1
(43) Pub. Date: Oct. 8, 2026

(54) OPTICAL BRIDGE INTERFACE WITH EVANESCENT COUPLING

(71) Applicant: Intel Corporation, Santa Clara, CA (US)

(72) Inventors: Dekang Chen, Chandler, AZ (US); Zhichao Zhang, Chandler, AZ (US); Feifei Cheng, Chandler, AZ (US); Ziyin Lin, Chandler, AZ (US); Fan Fan, Chandler, AZ (US); Cheng Li, Mesa, AZ (US)

(73) Assignee: Intel Corporation, Santa Clara, CA (US)

(21) Appl. No.: 19/170,390

(22) Filed: Apr. 4, 2025

(51) Int. Cl. G02B 6/42

(52) U.S. Cl. CPC G02B 6/4206

(57) ABSTRACT

Optical couplers enable communication to and/or from PIC (Photonic Integrated Circuit). The optical couplers are manufactured at wafer-scale and provide detachable coupling to an array of optical fibers. An optical coupler includes an optical bridge, where the optical bridge includes a pair of waveguides with a first pitch at a first portion of the bridge and a second pitch at a second portion of the bridge. Soft waveguides are coupled to the pair of waveguides at the first portion of the bridge by evanescent coupling.

### BACKGROUND

The demand for computing capabilities with enhanced data bandwidth is escalating in various domains, such as data centers and high-performance computing, e.g., for artificial intelligence (AI) and machine learning (ML) applications. This trend poses a significant challenge for the advancement of next-generation computing technologies. In response to this challenge, the emergence of Co-Packaged Optics (CPO) offers a promising solution. CPO integrates optical modules directly with the electrical die on the same package, eschewing the traditional approach of employing separate, pluggable modules. CPO combines the high-performance computing capabilities of EIC (Electric Integrated Circuits), including CPU and/or GPU, seamlessly with the high-bandwidth, low-power benefits of PIC (Photonic Integrated Circuit) modules for data transmission and switching. By consolidating the electrical and photonic components into a single, monolithic package, CPO facilitates a significant leap towards achieving exascale computing capability for next-generation technologies.

### BRIEF DESCRIPTION OF THE DRAWINGS

Embodiments will be readily understood by the following detailed description in conjunction with the accompanying drawings.

FIG. 1 illustrates a cross-sectional view of a vertical optical coupler, according to various embodiments.

FIG. 2 illustrates a top view of the vertical optical coupler of FIG. 1, according to various embodiments.

FIG. 3 illustrates a cross-sectional view of a first detachable vertical optical coupler, according to various embodiments.

FIG. 4A illustrates a first example top view of the vertical optical coupler of FIG. 3, according to various embodiments.

FIG. 4B illustrates a second example top view of the vertical optical coupler of FIG. 3 with staggered optical channels, according to various embodiments.

FIG. 5A illustrates a first cross-sectional view of a second detachable vertical optical coupler, according to various embodiments.

FIG. 5B illustrates a second cross-sectional view of the second detachable vertical optical coupler, according to various embodiments.

FIG. 6A illustrates a first example top view of the second vertical optical coupler of FIG. 5, according to various embodiments.

FIG. 6B illustrates a second example top view of the second optical vertical optical coupler of FIG. 5 with staggered optical channels, according to various embodiments.

FIG. 7 illustrates a cross-sectional view of a third detachable vertical optical coupler, according to various embodiments.

FIG. 8A illustrates a first example top view of the third vertical optical coupler of FIG. 7, according to various embodiments.

FIG. 8B illustrates a second example top view of the third optical vertical optical coupler of FIG. 7 with staggered optical channels, according to various embodiments.

FIGS. 9A, 9B, 9C, and 9D illustrate cross-sectional views of four example implementations of angled reflective surfaces for use in any of the embodiments of FIGS. 1-8.

FIG. 10 is a cross-section view of an optical bridge interface based on evanescent coupling, according to some various embodiments.

FIGS. 11A and 11B are two example detail cross-section views of the optical bridge interface of FIG. 10, according to some various embodiments.

FIG. 12 is an example top view of the optical bridge interface of FIG. 10, according to some various embodiments.

FIG. 13 is an example cross-section view of an optical coupler with stacked waveguides, according to some various embodiments.

FIG. 14A is an example detail top view of the three dimensional waveguides of FIG. 13, and FIGS. 14B and 14C are two cross-section views of the waveguides of FIG. 14A, according to some various embodiments.

FIG. 15 is an example cross-section view of an optical coupler with stacked waveguides and a reflector, according to some various embodiments.

FIG. 16 is a top view of a wafer and dies that may be included in a microelectronic package or a photonic device that includes or is used in conjunction with an optical coupler, according to an embodiment.

FIG. 17 is a side, cross-sectional view of an example microelectronic package that may include one or more optical couplers, according to an embodiment.

FIG. 18 is a block diagram of a photonic device that may include one or more optical couplers, according to an embodiment.

### DETAILED DESCRIPTION

The systems, methods and devices of this disclosure each have several innovative aspects, no single one of which is solely responsible for all of the desirable attributes disclosed herein. Details of one or more implementations of the subject matter described in this specification are set forth in the description below and the accompanying drawings.

For purposes of illustrating the optical interfaces proposed herein, it might be useful to first understand phenomena that may come into play in context of CPO systems. The following foundational information may be viewed as a basis from which the present disclosure may be properly explained. Such information is offered for purposes of explanation only and, accordingly, should not be construed in any way to limit the broad scope of the present disclosure and its potential applications.

Metal communication lines, such as copper or aluminum wires, have traditionally been used for communication within and between microelectronic devices. Metals are excellent conductors of electricity, and they facilitate the transmission of electrical signals over short distances at very high speeds. Metal interconnects are commonly used for on-chip communication, connecting transistors, logic gates, and other components within a microchip. However, as microelectronics have continued to shrink in size and increase in complexity, the limitations of metal interconnects have become more apparent. These limitations include resistance, capacitance, and signal propagation delays, which can lead to power consumption, heat generation, and signal integrity issues.

Optical communications provide an alternative to metal interconnects in microelectronics. Optical connections use light to transmit data within and between electronic components. Optical communications can address some of the limitations of metal interconnects and offer several advantages, including high-speed data transfer, immunity to electromagnetic interference, and lower power consumption.

In CPO systems, the optical I/O architecture plays a critical role in determining the bandwidth of the CPO system. Firstly, the I/O architecture establishes the channel density, defining the total number of channels within a given form factor. Secondly, it dictates the spectral bandwidth of the optical signal, which in turn determines the modulation states within each channel. However, conventional optical I/O architectures often present a trade-off between the high-density and broadband features, which significantly limits the bandwidth capabilities of CPO solutions.

For major CPO products on market, existing solutions for fiber-to-chip coupling include edge coupling by V-groove structures and vertical coupling using grating couplers. Edge couplers offer the advantage of broad bandwidth and easy assembly, while vertical couplers based on grating couplers provide high channel density but limited spectrum width. Furthermore, both of these solutions require post-assembly attachment, which presents high difficulty in alignment control and limits the yield for scalable production.

In the edge coupler setup, an optical signal from a PIC is transmitted through a spot size converter (SSC), e.g., an inverted taper, which expands the small optical mode from the PIC waveguide to a size that is comparable to the beam dimension in an optical fiber (approximately 9 to 10 μm). To ensure placement accuracy between the fiber and SSC, typically within a range of 1 to 2 μm, a V-shaped groove (V-groove) is etched onto the silicon substrate using lithography and anisotropic wet etching along the crystal orientation. The edge coupler architecture offers an easy assembly process, as the fiber can be fixed onto a wafer-level processed features that are integrated on the PIC. This advantage makes it the most widely used structure in conventional CPO products. Additionally, since edge coupling is insensitive to optical wavelength, a broad optical spectrum can be supported. However, a significant drawback of the edge coupler is its limitation in channel density. Due to the edge coupler's configuration, the channels are arranged in a 1D array. As the number of channels increases, the dimension of the coupler escalates, making it difficult to further improve the system's bandwidth and form factor.

In contrast, the vertical coupler configuration has advantages and disadvantages opposite to those of the edge coupler. Grating couplers, which include sub-micron periodic features, can receive optical beams from the vertical direction and couple them into transverse waveguides through the diffraction effect. With vertical coupling, fibers can be arranged in 2D arrays, which significantly improves channel density compared to the 1D array in edge coupling scenarios. However, grating couplers also have notable drawbacks. First, since grating couplers operate based on the diffraction effect, their efficiency is strongly dependent on the optical wavelength, so that they only work at a narrow spectrum band. Additionally, the theoretical efficiency of the grating coupler is typically around 80%, resulting in higher losses than the edge coupler. Moreover, since vertical coupling cannot utilize integrated features on PIC, such as V-groove, for fiber alignment, the assembly process is also much more complex. Consequently, it is difficult for either of these conventional I/O solutions to simultaneously achieve high channel density and broad optical bandwidth.

I/O architectures for interconnecting optical fibers to photonic integrated circuits (PICs) that simultaneously support high channel density and broad optical bandwidth are described herein. The proposed architectures are compatible with wafer-level processing to provide high alignment accuracy and low cost for scalable manufacturing. Several architectures employ expanded beam technology to improve alignment tolerance, enabling the coupler to be detachable and can function as a user interface.

In some embodiments, an optical I/O architecture for CPO is based on vertical coupling. The vertical coupling arrangements described herein achieve high-density 2D channel arrays while still supporting a broad optical band, thereby providing significantly higher bandwidth capability compared to conventional CPO solutions. The vertical optical coupler can function as a detachable user interface by utilizing an expanded beam design.

In some embodiments, a lens on one portion of the vertical coupler (e.g., a detachable unit attached to an array of optical fibers) is arranged directly over a corresponding lens on the other side of the vertical coupler (e.g., a PIC). The lenses may be vertically arranged over a mirror that reflects an incoming horizontal optical signal into the vertical direction and through the stacked lenses. In other embodiments, the fiber-attached portion of the vertical coupler may have a curved reflector that directs a vertical optical signal towards a horizontally-attached optical fiber. In still other embodiments, a pair of lenses on the two sides of the vertical coupler may be arranged to provide a self-locking mechanism, which can further increase the alignment tolerance of the vertical coupler.

As noted above, data transmission bandwidth is a crucial performance metric for CPO products. In conventional CPO solutions, one of the primary limitations on data bandwidth is the channel density, which arises due to the substantial dimension mismatch between the optical fibers and the PIC waveguides. For PIC waveguides, 5 to 10 μm pitch distance between waveguides is typically sufficient to avoid crosstalk between channels. However, standard optical fibers have significantly larger dimensions than PIC waveguides, typically with a diameter of 125μm, which significantly limits the maximum channel density for PIC-to-Fiber I/O interface. This results in a limited bandwidth for current CPO products or requires a much larger form factor.

In some embodiments, an optical I/O architecture based on evanescent coupling and including a two-stage pitch scaling capability is disclosed. This architecture can achieve channel density more than ten times higher than conventional I/O solutions, significantly improving the bandwidth capability of CPO products. The soft-material-based coupler described offers improved loss performance, flexibility, and stability compared to prior glass-based couplers. These embodiments include an optical bridge in which die-to-die optical connections enable integration of optical modules with diverse functions. As in other embodiments, the fabrication can be accomplished during wafer-level processing, which promotes scalable manufacturing with low cost.

In some embodiments, a 3D waveguide structure is bonded to a PIC at the wafer level with high precision. Evanescent coupling is used to communicate optical signals between waveguides in the 3D waveguide structure and silicon waveguides within the PIC. Waveguides within the 3D waveguide structure are arranged to convert a 2D array of channels to a 3D array, with multiple stacked waveguides. This enables the connection interface to be scaled up from a 1-D array to a 2-D array, which increases the maximum number of optical channels in an interface between a PIC and a fiber array.

In the following detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made, without departing from the scope of the present disclosure. Therefore, the following detailed description is not to be taken in a limiting sense.

Any of the features discussed with reference to any of accompanying drawings herein may be combined with any other features to form an optical coupler, a microelectronic package 2200, or a photonic device 2300, or a package including one or more devices (e.g., a CPO system), as appropriate. A number of elements of the drawings with same reference numerals may be shared between different drawings; for ease of discussion, a description of these elements provided with respect to one of the drawings is not repeated for the other drawings, and these elements may take the form of any of the embodiments disclosed herein. The drawings are not necessarily to scale. Although some of the drawings illustrate rectilinear structures with flat walls/surfaces and right-angle corners, this is simply for ease of illustration and may not reflect real-life process limitations which may cause various features to not look so “ideal” when any of the structures described herein are examined using e.g., scanning electron microscopy (SEM) images or transmission electron microscope (TEM) images. In such images of real structures, possible processing defects could also be visible, e.g., not-perfectly straight edges of materials, tapered vias or other openings, inadvertent rounding of corners or variations in thicknesses of different material layers. There may be other defects not listed here but that are common within the field of semiconductor device fabrication and packaging. Inspection of layout and mask data and reverse engineering of parts of a device to reconstruct the circuit using e.g., optical microscopy or transmission electron microscopy, and/or inspection of a cross-section of a device to detect the shape and the location of various device elements described herein using, e.g., Physical Failure Analysis (PFA) would allow determination of presence of optical couplers as described herein.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). When used to describe a range of dimensions, the phrase “between X and Y” represents a range that includes X and Y. When used to describe a location of an element, the phrase “between X and Y” represents a region that is spatially between element X and element Y. The terms “substantially,” “close,” “approximately,” “near,” and “about,” generally refer to being within +/−20%, e.g., within +/−5% or within +/−2%, of a target value based on the context of a particular value as described herein or as known in the art. Similarly, terms indicating orientation of various elements, e.g., “coplanar,” “perpendicular,” “orthogonal,” “parallel,” or any other angle between the elements, generally refer to being within +/−10%, e.g., within +/−5% or within +/−2%, of the exact orientation.

The description uses the phrases “in an embodiment” or “in embodiments,” which may each refer to one or more of the same or different embodiments. Furthermore, the terms “comprising,” “including,” “having,” and the like, as used with respect to embodiments of the present disclosure, are synonymous. As used herein, the terms “package” and “integrated circuit (IC) package” are synonymous, as are the terms “die” and “IC die.” Furthermore, the terms “chip,” “chiplet,” “die,” and “IC die” may be used interchangeably herein. Although certain elements may be referred to in the singular herein, such elements may include multiple sub-elements. For example, “an insulator material” may include one or more insulator materials.

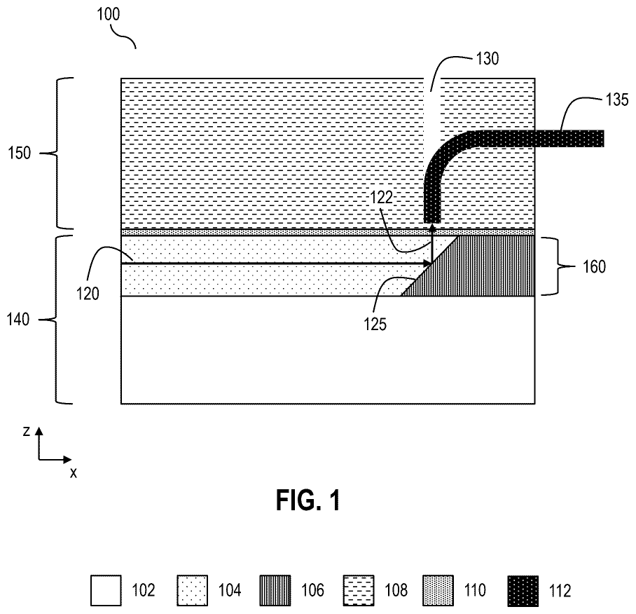

FIG. 1 illustrates a 2D cross-sectional view of a vertical optical coupler 100. The vertical optical coupler 100 couples together a PIC 140 and a Fiber Attached Unit (FAU) 150. On the PIC side, to enable vertical beam coupling without spectral width limitations, a reflective surface 125 is utilized to deflect the beam 120; this is different from conventional vertical coupler configurations that employ grating coupling, as described above. The reflective surface 125 can be fabricated during the wafer-level process, e.g., using grey-scale lithography to produce a sloped surface for forming the reflective surface 125. The beam deflection can be achieved either by total internal reflection (TIR) or by a high-reflection coating (HRC) along the sloped surface. For example, the reflective surface 125 may include a low refractive index material such as air, or a high reflective material such as aluminum.

On the FAU 150 side, a monolithic fiber housing is fabricated with 2D ferrule arrays to guide the optical fiber and bend their directions vertically. Monolithic fiber housing can be processed based on multiple materials, such as laser-assisted etching on bulk glasses or Two-Photon Polymerization (2PP) 3D printing on polymer materials. The FAU 150 is assembled with the PIC 140 via physical surface contact using wafer bonding techniques, e.g., at a bonding layer that includes the bonding material 110. Therefore, a high-density and broadband-supporting optical I/O architecture is achieved fully through wafer-level processing.

A number of elements referred to in the description of FIGS. 1-15 with reference numerals are illustrated in these figures with different patterns, with a legend at the bottom of the page showing the correspondence between the reference numerals and patterns. The legend illustrates that FIG. 1 uses different patterns to show a support structure 102, an optical material 104, a mirror 106, a housing material 108, a bonding material 110, and an optical fiber 112.

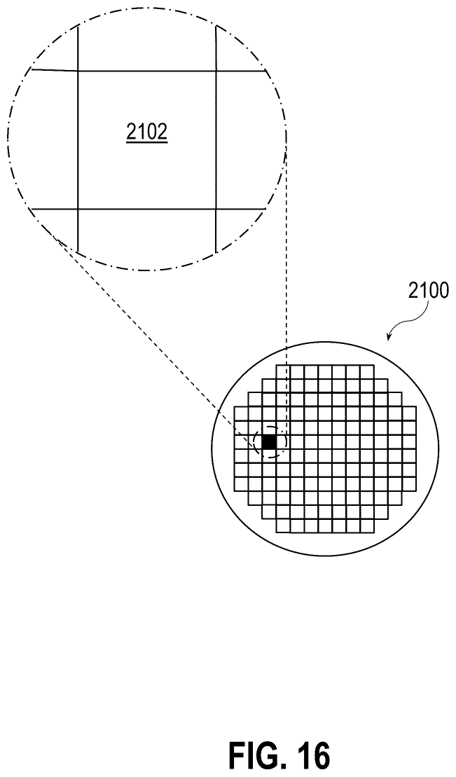

In general, implementations of the present disclosure may be formed or carried out on a support structure, e.g., the support structure 102 illustrated in FIG. 1. The support structure 102 may be, e.g., a substrate, a die, a wafer or a chip. For example, the support structure 102 may be the wafer 2100 of FIG. 16A, discussed below, and may be, or be included in, a die, e.g., the singulated die 2102 of FIG. 16B, discussed below. The support structure 102 extends along the x-y plane in the coordinate system shown in FIG. 1.

In some embodiments, the support structure 102 may be a substrate that includes silicon and/or hafnium. More generally, the support structure may be a semiconductor substrate composed of semiconductor material systems including, for example, N-type or P-type materials systems. In one implementation, the semiconductor substrate may be a crystalline substrate formed using a bulk silicon or a silicon-on-insulator (SOI) substructure. In other implementations, the semiconductor substrate may be formed using alternate materials, which may or may not be combined with silicon, that include, but are not limited to, germanium, silicon germanium, indium antimonide, lead telluride, indium arsenide, indium phosphide, gallium arsenide, aluminum gallium arsenide, aluminum arsenide, indium aluminum arsenide, aluminum indium antimonide, indium gallium arsenide, gallium nitride, indium gallium nitride, aluminum indium nitride or gallium antimonide, or other combinations of group III-V materials (i.e., materials from groups III and V of the periodic system of elements), group II-VI (i.e., materials from groups II and IV of the periodic system of elements), or group IV materials (i.e., materials from group IV of the periodic system of elements). In some embodiments, the substrate may be non-crystalline. In some embodiments, the support structure may be a printed circuit board (PCB) substrate. Although a few examples of materials from which the substrate may be formed are described here, any material that may serve as a foundation upon which a PIC with an optical coupler, e.g., the optical couplers as described herein, may be built falls within the spirit and scope of the present disclosure.

An optical material 104 is over the support structure 102. The optical material 104 provides one or more optical channels, e.g., an optical channel for the beam 120, as illustrated in FIG. 1. The optical material 104 may be in an optical layer 160 that includes one or more waveguides for transmitting optical signals. Each optical layer 160 may include one or more other materials forming the boundaries of the waveguide and preventing leakage of optical signals from the waveguides; such materials may be referred to as cladding or isolation materials. Multiple isolation materials may be used along different edges or portions of a waveguide. For example, a waveguide having a rectangular cross-section may be formed over a first isolation layer, so a bottom face of the waveguide is coupled to the first isolation layer. A second isolation material may be deposited over the waveguide, so that the second isolation layer surrounds the sides and top face of the waveguide.

The optical material 104 within a waveguide (also referred to as the waveguide material) has a uniform crystal structure that allows an optical wave to propagate through the waveguide material with minimal loss. For example, the waveguide material may have grain size of at least 5 nanometers. In some embodiments, the waveguide material has a larger minimum grain size, e.g., a grain size of at least 50 nanometers, or a grain size of at least 100 nanometers. The waveguides may be formed of any suitable single-crystal material, such as sapphire, quartz, silicon, a compound of silicon (e.g., silicon oxide or silicon nitride), indium phosphide, germanium or a germanium alloy, gallium, arsenic (e.g., an arsenide III compound, where arsenic III is in combination with another element such as boron, aluminum, gallium, or indium), or any group III-V material (i.e., materials from groups III and V of the periodic system of elements).

The isolation material is a material without optical properties, or with different optical properties from the waveguide. For example, the isolation material may include a polycrystalline or amorphous silicon or silicon compound, such as silicon dioxide or silicon nitride. In some embodiments, the isolation material is a single-crystal material with different optical properties than the waveguide, e.g., a monocrystalline material (e.g., single-crystal silicon, gallium arsenide, or any of the other monocrystalline materials mentioned above) with a higher refractive index than the waveguide. In some embodiments, multiple isolation layers are formed of two or more different isolation materials.

In some embodiments, the waveguide material has a refractive index between 1.3 and 4. An isolation material abutting at least a portion of the waveguide may also have a different refractive index between 1.3 and 4. The waveguide material and isolation material may be selected such that the isolation material has a much higher or much lower refractive index than the waveguide material. In some embodiments, the isolation material and the waveguide material may have a similar or same refractive index. In such embodiments, an interface between the waveguide material and the isolation material may prevent leakage of signals into the isolation material, e.g., if the crystal structures of the waveguide material and the isolation material are different, or if the crystal structure restarts at the interface (e.g., if the isolation material and waveguide material are grown separately).

In some embodiments, the optical layer 160 further includes photonic components to manipulate the optical signals, such as gain chips, diffraction gratings, combiners, demodulators, etc. The photonics components may include any of the waveguide materials described above. In some embodiments, the optical layer 160 may include electro-optical components, e.g., an electro-optic modulator such as a Mach-Zehnder modulator or a ring oscillator.

The optical material 104 includes an optical channel extending in a first direction; in this example, the optical channel, represented by the beam 120, extends in the x-direction. The path of the beam 120 is parallel to the plane of the support structure 102. The beam 120 is incident on a reflector, e.g., the mirror 106, at an end of the optical channel. The mirror 106 has a reflective surface 125 that is angled relative to the first direction, e.g., the x-direction. In the example shown, the reflective surface 125 is angled at approximately 45° relative to the x-direction. In other examples, the reflective surface 125 may be angled at, e.g., between 30° and 60° relative to the x-direction, or by another amount. The reflective surface is not parallel or perpendicular to the direction of the incoming beam 120.

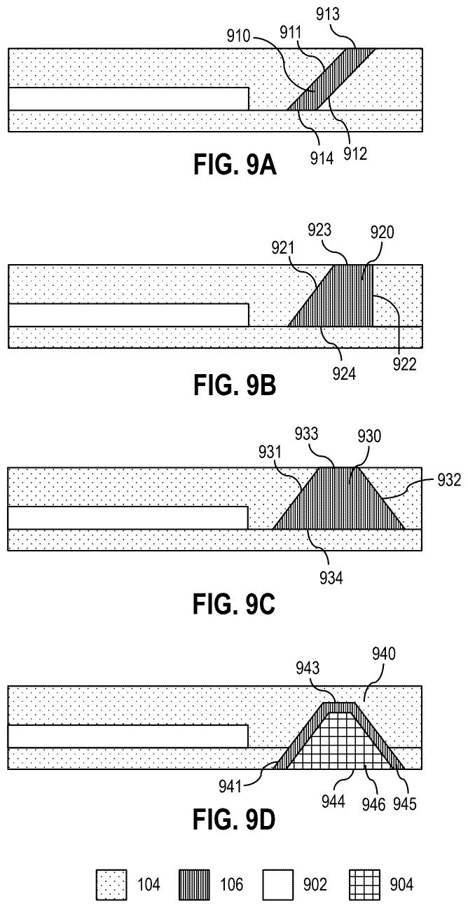

The mirror 106 may have different structures behind the angled face. FIGS. 9A-9D, discussed below, illustrate several different arrangements of the mirror 106, which may be fabricated using different fabrication processes. The reflective surface 125 may be a high-reflection coating (HRC) over the angled face of the mirror 106. Alternatively, the mirror 106 may be a total internal reflection (TIR) reflector.

As noted above, the FAU 150 is bonded over the PIC 140, and in particular, over the optical layer 160. The bonding material 110 may be an adhesive material that ensures attachment of the FAU 150 and the PIC 140 to one another. The bonding material 110 enables transmission of the reflected beam 122 from the reflective surface 125 into the FAU 150.

The FAU 150 includes the housing material 108, which may be, e.g., a glass material, a polymer material, or another suitable material for holding the optical fiber 135. An end of the optical fiber 135 is arranged to receive the reflected beam 122. In this example, the reflected beam 122 extends through a small portion of the housing material 108; in such embodiments, the housing material 108 enables transmission of the reflected beam 122 into the end of the optical fiber 135. In other embodiments, the optical fiber 135 extends to the bonding material 110, and the housing material 108 may or may not enable transmission of an optical signal.

The optical fiber 135 is bent within the FAU 150, and a vent hole 130 is directly over an end of the optical fiber 135 that receives the reflected beam 122. The optical fiber 135 may extend out of the FAU 150 in the x-direction, as shown in FIG. 1, or in another direction (e.g., in the y-direction). The optical fiber 135 may have a bend of 90°, as shown; proximate to the reflected beam 122, the optical fiber 135 extends in the z-direction, and after the vent hole 130, the optical fiber 135 extends in the x-direction.

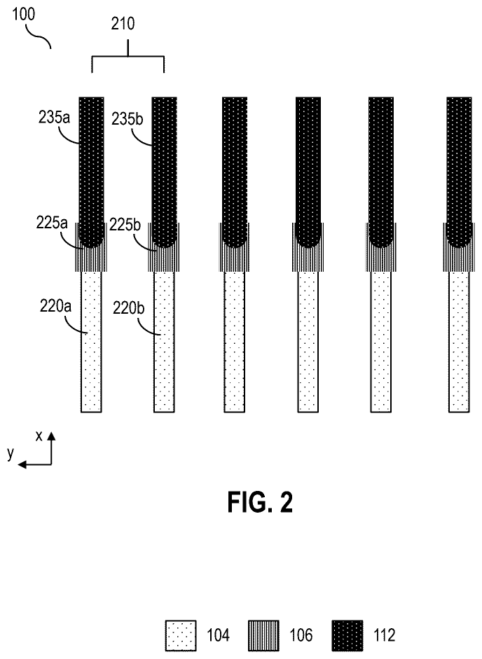

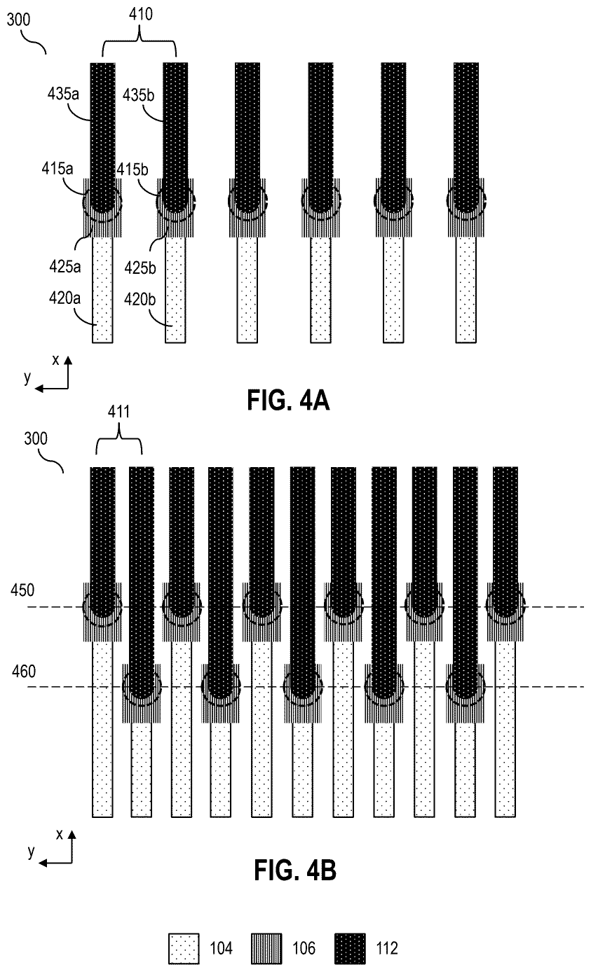

FIG. 2 illustrates a top view of multiple optical interfaces which may be included in the vertical optical coupler 100. FIG. 2 illustrates six optical pathways, each of which includes a waveguide 220 formed in the optical material 104, a reflective surface 225 (corresponding to the reflective surface 125), and an optical fiber 235 (corresponding to the optical fiber 135). For example, a first optical pathway including waveguide 220a, reflective surface 225a, and optical fiber 235a may be a top view of the optical pathway illustrated in FIG. 1. In particular, the first optical pathway includes waveguide 220a, which may correspond to a portion of the optical material 104 that transmits the beam 120; reflective surface 225a, which may correspond to the reflective surface 125 in FIG. 1; and optical fiber 235a, which corresponds to the optical fiber 135 in FIG. 1. To aid in illustration, the housing material 108 and bonding material 110 are not shown. As another example, the second optical pathway includes waveguide 220b, reflective surface 225b, and optical fiber 235b, which are similar to 220a, 225a, and 235a. The optical pathways extend parallel to each other and at a pitch of 210. The pitch 210 may be, e.g., between 50-250 μm or any range therein. In some embodiments, the reflective surfaces may be staggered, e.g., as shown in the example of FIG. 4B.

The architecture illustrated in FIGS. 1 and 2 is not suitable for a detachable interface due to the high alignment accuracy required between the FAU 150 and the PIC 140. The alignment requirement arises from the inherent short wavelength nature of the optical communication (e.g., between 1.31 and 1.55 μm), resulting in the mode field diameter (MFD) of both the single-mode fiber (SMF) and the SSC typically being around 10 μm. Since the coupling efficiency is determined by the integrated overlap of the optical modes in the fiber and SSC, a misalignment of 1 or 2 μm between the FAU 150 and the PIC 140 can lead to significant coupling loss. Therefore, the PIC 140 and FAU 150 are aligned and permanently bonded, using the bonding material 110. Since the challenge of alignment control arises from the small MFD, tolerance requirement may be relaxed by increasing the MFD. By increasing the beam dimension, the alignment tolerance can be significantly improved, enabling a detachable interface.

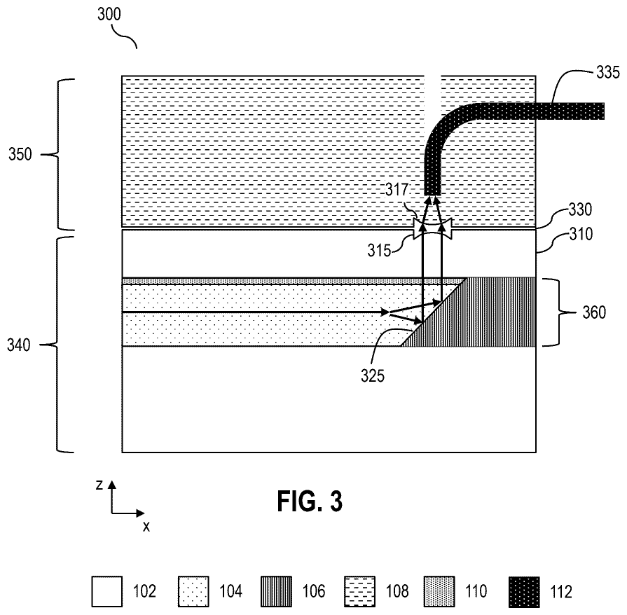

FIG. 3 illustrates a detachable vertical optical coupler 300 in which the FAU may be detachably coupled to the PIC. To enable detachability, the vertical optical coupler 300 employs an expanded beam feature, in which two optical lenses are included, one on the FAU side and one on the PIC side, to collimate the diverged beams. The PIC 340 is similar to the PIC 140 and includes the support structure 102 and an optical layer 360 similar to the optical layer 160, but the PIC 340 further includes an additional lens array layer 310 over the optical material 104. The lens array layer 310 includes a lens 315 arranged over the reflector 325. An optical path from the reflector 325 to the lens 315 is perpendicular to the optical path of the beam incident on the reflector 325, e.g., the incoming beam to the reflector 325 is in the x-direction, and the path between the reflector 325 and the lens 315 is along the z-direction. In some cases, lens array layer 310 is an integrated lens formed directly on optical layer 360. In some embodiments, lens array layer 310 is formed as a separate die that is attached on top of optical layer 360, e.g., by bonding; in such embodiments, the base PIC (including optical layer 360 and support structure 302) and the lens array layer 310 may be jointly referred to as a PIC assembly or photonic device assembly, for example, or as PIC 340.

The lens 315 is a convex lens that collimates a beam reflected from the reflector 325 and travelling through the lens 315 towards the FAU 350. The lens array layer 310 may include silicon or another single-crystal material, e.g., any of the materials described above with respect to the support structure 102 or the optical material 104. In other embodiments, the lens array layer 310 may include silica or polymer; the lens 315 may be, e.g., a silicon lens or other single-crystal lens, a silica lens, or a polymer lens, for example. The lens 315 may be fabricated using grey-scale lithography and bonded to the top surface of the optical layer 360, e.g., using bonding material 110. The lens array layer 310 may include an array of multiple lenses, e.g., as shown in FIGS. 4A and 4B.

The FAU 350 includes a lens 317 arranged over the lens 315 of the PIC 340. The lens 317 may be formed in the housing material 108 using, e.g., grey-scale lithography or three-dimensional printing. The lens 317 may be a convex lens that has a focal point within the housing material 108. An end of the optical fiber 335 may be at or near (e.g., within 1 μm, within 3 μm, within 10 μm, or within 20 μm) of the focal point of the lens 317. A vent hole similar to the vent hole 130 extends through the housing material 108; the vent hole extends in the z-direction between an upper surface of the FAU 350 and the bend in the optical fiber 335.

The reflector 325 and lens 315 result in an output beam with an expanded beam dimension and, thus, the optical beam dimension between the FAU 350 and PIC 340 is larger than in prior interfaces. The expanded beam can provide misalignment tolerance up to 10 times larger than prior optical interfaces, which enables detachability between the PIC 340 and the FAU 350. In particular, at the interface 330 between an upper face of the PIC 340 and a lower face of the FAU 350, the FAU 350 can be removed from the PIC 340 and re-attached. As another example, a different PIC 340 may be attached to the FAU 350 or vice versa (e.g., if a first PIC, or package containing the first PIC, within a larger system containing an FAU has a fault, it can is replaced by attaching a second PIC or a second package to the same FAU).

Meanwhile, accurate alignment between lens array layer 310 and the optical layer 360, and between the lens 317 and the optical fiber 335, can be achieved during the wafer-level processing of each component. Consequently, detachability can be achieved between the FAU and PIC due to the expended beam dimension, while both FAU 350 and PIC 340 can be pre-manufactured through wafer-level process as a monolithic part for assembly. In addition, by modifying the curvature of the lens 315 and/or the lens 317, a beam dimension from the 335 fiber can be adaptively matched with the optical mode in the PIC 340.

FIG. 4A illustrates a top view of multiple optical interfaces which may be included in the vertical optical coupler 300. FIG. 4A illustrates six optical pathways, each of which includes a waveguide 420 formed in the optical material 104, a reflective surface 425, a lens stack 415, and an optical fiber 435. For example, a first optical pathway including waveguide 420a, reflective surface 425a, lens stack 415, and optical fiber 435a may be a top view of the optical pathway illustrated in FIG. 3. In particular, the first optical pathway includes waveguide 420a, which may correspond to a portion of the optical material 104 that transmits the beam; reflective surface 425a, which may correspond to the reflector 325 in FIG. 3; the lens stack 415a, which includes the lens 315 and 317; and optical fiber 435a, which corresponds to the optical fiber 335 in FIG. 3. Because the lenses 315 and 317 are stacked over each other, they are represented with a single circular outline for the lens stack 415a. To aid in illustration, the housing material 108, bonding material 110, and material of the lens array layer 310 (other than the outline of the lens stack 415a) are not shown. As another example, the second optical pathway includes waveguide 420b, reflective surface 425b, lens stack 415a, and optical fiber 435b, which are similar to 420a, 425a, 415a, and 435a. The optical pathways extend parallel to each other and at a pitch of 410. The pitch 410 may be, e.g., between 50-250 μm.

In some embodiments, the reflective surfaces and lens stacks may be staggered, e.g., as shown in the example of FIG. 4B. FIG. 4B illustrates an alternate top view of the optical interfaces which may be included in the vertical optical coupler 300. In FIG. 4A, the lens stacks 415 and reflective surfaces 425 are arranged along a single line. In FIG. 4B, the lens stacks 415 are arranged along two lines 450 and 460, or two arrays, that are parallel to each other and offset from each other, e.g., at different positions along the x-direction. Likewise, the reflective surfaces 425, which are arranged below the lens stacks 415 (as shown in FIG. 3), are also arranged along the two lines or two arrays 450 and 460. Staggering the lenses and reflective surfaces in this way may allow a tighter pitch 411 between adjacent optical pathways relative to the arrangement of FIG. 4A. For example, the pitch 411 may be between 25-125 μm.

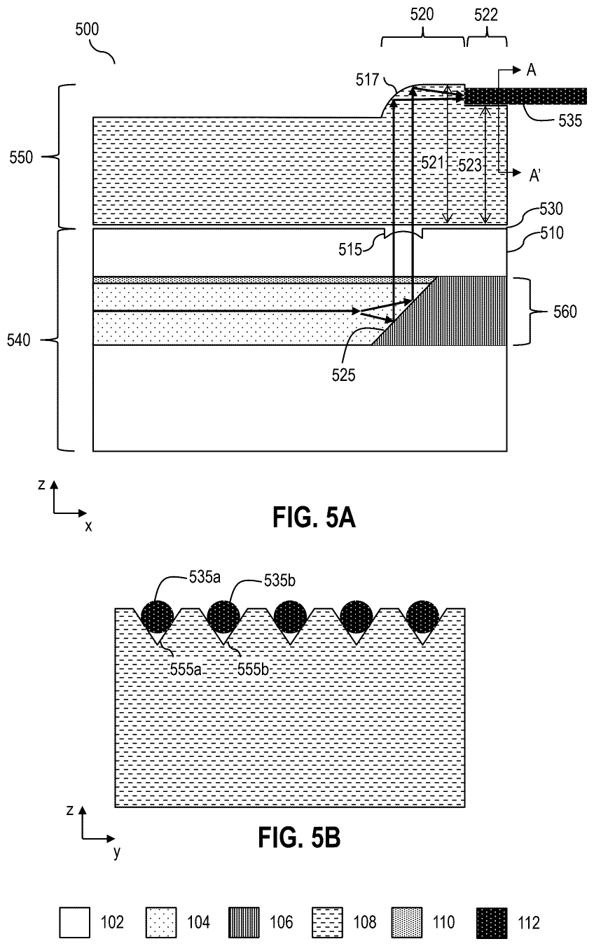

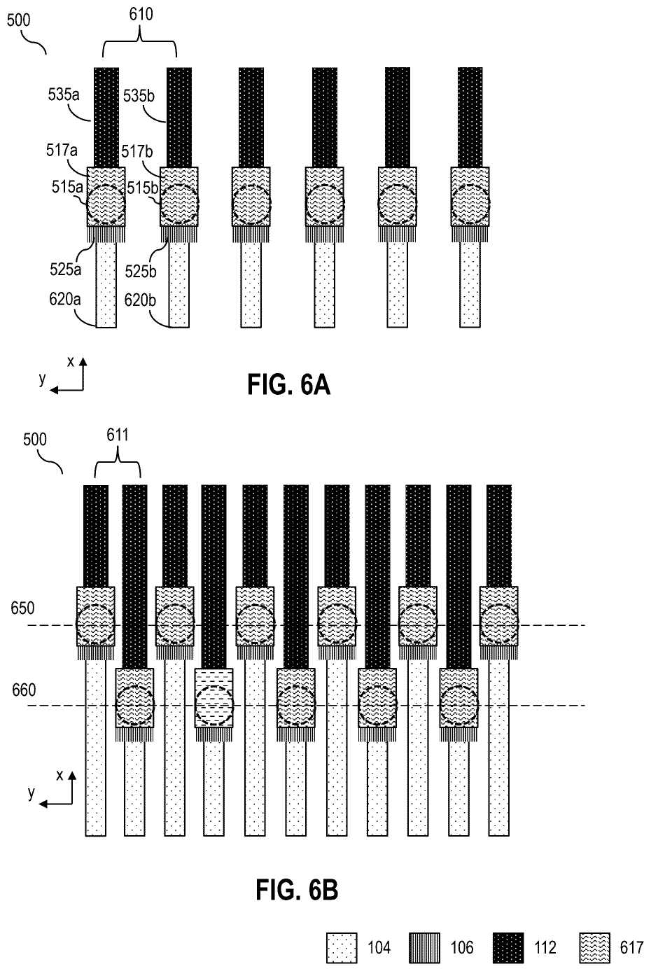

FIGS. 5A, 5B, 6A, and 6B illustrate embodiments of a second detachable vertical optical coupler 500. FIG. 5A illustrates a first cross-sectional view of a second detachable vertical optical coupler, and FIG. 5B illustrates a second cross-sectional view of the second detachable vertical optical coupler, through the plane AA′ in FIG. 5A. The second optical coupler design includes a PIC 540 that is similar to the PIC 340. The PIC 540 includes an optical layer 560 that is similar to the optical layer 360; the optical layer 560 includes a reflector 525 that is similar to the reflector 325. The reflector 525 deflects a beam traveling through the optical layer 560. The PIC 540 further includes a lens array layer 510 bonded over the optical layer 560, similar to the lens array layer 310 over the optical layer 360. The lens array layer 510 includes a lens 515 that is similar to the lens 315.

The second optical coupler design has an FAU 550 that has a different design from the FAU 350. In some embodiments, the FAUs 350 and 550 may each be able to be coupled to the same PIC, e.g., either the FAU 350 or the FAU 550 can be coupled to the PIC 340. In the example of FIG. 5, the FAU 550 is a monolithic fiber housing with a V-groove structure to align the optical fibers 535. The FAU 550 further includes a curved mirror 517 that is integrated on the upper side of the FAU 550, near the fiber tip. The curved mirror 517 may be a TIR or HRC reflector, as described above. An optical path from the reflector 525 to the curved mirror 517 is perpendicular to the optical path of the beam incident on the reflector 525, e.g., the incoming beam to the reflector 525 is in the x-direction, and the path between the reflector 525 and the curved mirror 517 is along the z-direction.

For an optical signal from the FAU 550 to the PIC 540, with the assistance of TIR or HRC in the curved mirror 517, an optical beam from the optical fiber 535 is expanded and collimated by the curved mirror 517, achieving an expanded beam on the FAU side. Alternatively, an expanded beam transmitted from the PIC 540 and through the FAU 550 is focused by the curved mirror 517 at an input to the optical fiber 535. The monolithic fiber housing for the FAU 550 can be processed using various materials and processes, such as laser-assisted etching on bulk glasses. The FAU 550 offers high flexibility, allowing the fabrication of alignment features (e.g., the V-grooves structures) and optical features (e.g., the curved mirrors 517) on the same block with very high precision control (e.g., <1 μm).

The embodiment shown in FIG. 5 enables detachability between the FAU 550 and PIC 540 due to the expended beam dimension. Furthermore, both the FAU 550 and PIC 540 can be pre-manufactured through wafer-level process as a monolithic parts for assembly. In addition, the lens 515 and curved mirror 517 in this design can be tuned to adapt the MFD difference between the optical fiber 535 and the SSC (e.g., the reflector 525); this can reduce the nominal coupling loss compared with prior coupling solutions.

The FAU 550 includes a layer of the housing material 108, which in this embodiment is a medium for transmitting optical signals, so that the optical beam can travel through the housing material 108. For example, the housing material 108 may be glass. An array of curved mirrors, e.g., the curved mirror 517, are formed over a first portion 520 of the layer of the housing material 108. The curved mirrors are configured to deflect a beam that travels through the layer of the 108, e.g., to deflect the beam transmitted from the reflector 525 towards the optical fiber 535, as illustrated in FIG. 5A. The first portion 520 has a maximum height 521 between a base of the FAU 550 at the interface 530 with the PIC 540 and an uppermost portion of the mirror 517. The height of the first portion 520 varies with the curvature of the mirror 517. The FAU 550 further includes an array of optical fibers, e.g., the optical fiber 535, over a second portion 522 of the layer of the housing material 108. The second portion 522 of the layer of the housing material 108 has a height 523, which is lower than the maximum height 521 of the first portion 520 of the layer of the housing material 108 where the mirrors 517 are formed. The optical fiber 535 has an input arranged to receive a deflected beam from the curved mirror 517. Each similar optical fiber along the array has an input arranged to receive a deflected beam from a corresponding one of the array of curved mirrors, e.g., as shown in FIG. 6.

FIG. 5B illustrates the array of optical fibers, e.g., optical fibers 535a and 535b, arranged in V-grooves 555, e.g., V-grooves 555a and 555b, formed in the housing material 108. As noted above, the V-grooves 555 are grooved structures formed in the housing material 108 that can be precisely fabricated in the housing material 108 to provide a high degree of alignment between ends of the optical fibers 535 and the curved mirrors 517. The housing material 108 with the array of curved mirrors 517 and the array of corresponding V-grooves 555 may be formed as a single optical structure that is coupled to the array of optical fibers 535.

The FAU 550 is configured to attach and detach from the PIC 540 along the interface 530. As noted above, the optical signals transmitted across the interface 530 (e.g., from the PIC 540 to the FAU 550) are expanded beams, e.g., the optical signals may have a beam dimension of at least 5 μm, at least 10 μm, at least 20 μm, at least 50 μm, between 20-200 μm, or between 50-100 μm. At the interface 530, and particularly, within the portion of the interface 530 through which the optical beams travel, the PIC 540 and FAU 550 may be planar. Other portions of the interface 530 may include alignment features and/or connection features for coupling the PIC 540 to the FAU 550.

The arrangement of the array of curved mirrors 517 corresponds to the arrangement of the array of lenses in the PIC 540. FIG. 6A illustrates a top view of multiple optical interfaces which may be included in the vertical optical coupler 500. FIG. 6A illustrates six optical pathways, each of which includes a waveguide 620 formed in the optical material 104, a reflector 525, a lens 515, a curved mirror 517, and an optical fiber 535. For example, a first optical pathway including waveguide 620a, reflector 525a, lens 515a, curved mirror 517a, and optical fiber 535a may be a top view of the optical pathway illustrated in FIG. 5A. The reflector 525 is illustrated with pattern corresponding to a reflective surface 617, e.g., an HRC or TIR surface. To aid in illustration, the housing material 108, bonding material 110, and material of the lens array layer 510 (other than the outlines of the lenses 515) are not shown. As another example, the second optical pathway includes waveguide 620b, reflector 525b, lens 515b, curved mirror 517b, and optical fiber 535b. The optical pathways extend parallel to each other and at a pitch of 610. The pitch 610 may be, e.g., between 50-250 μm.

In some embodiments, stacks of reflectors, lenses, and curved mirrors be staggered, e.g., as shown in the example of FIG. 6B. FIG. 6B illustrates an alternate top view of the optical interfaces which may be included in the vertical optical coupler 500. In FIG. 6A, the reflectors, lenses, and curved mirrors are arranged along a single line. In FIG. 6B, stacks of reflectors, lenses, and curved mirrors are arranged along two lines 650 and 660, or two arrays, that are parallel to each other and offset from each other, e.g., at different positions along the x-direction. Each of the arrays 650 and 660 extend along the y-direction, which is perpendicular to the incoming path of the optical beam towards the reflector 525 (i.e., the x-direction), and perpendicular to the reflected path of the optical beam through the interface 530 (i.e., the z-direction). Staggering the reflectors, lenses, and curved mirrors in this way may allow a tighter pitch 611 between adjacent optical pathways relative to the arrangement of FIG. 6A. For example, the pitch 611 may be between 25 and 125 μm.

In the example of FIG. 6B, V-grooves 555 corresponding to different curved mirrors have different lengths, with a first portion of the V-grooves 555 corresponding to curved mirrors along the array 650 being shorter than a second portion of the V-grooves 555 corresponding to curved mirrors along the array 660. Said another way, in the x-direction, the V-grooves corresponding to curved mirrors along the array 660 extend in a position nearer to the curved mirrors along the array 660 than V-grooves corresponding to curved mirrors along the array 650. The shorter V-grooves and longer V-grooves are alternating, e.g., each of the shorter V-grooves is between an adjacent pair of the longer V-grooves.

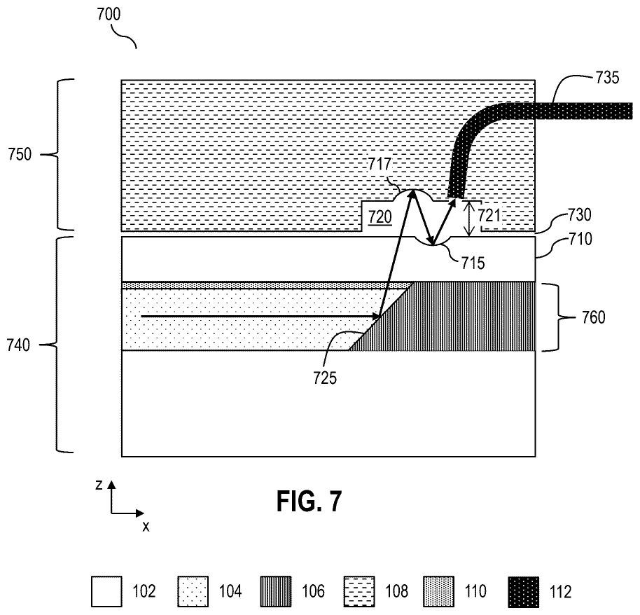

FIG. 7 illustrates a cross-sectional view of a third detachable vertical optical coupler 700, according to various embodiments. The vertical optical coupler 700 includes a self-locking based coupling solution through the design of a specific geometric relationship among the optical components. The self-alignment design inherently maintains symmetry in the light path, and improves offset tolerances, e.g., allowing tolerances that are between two times and three times tolerances of expended-beam-based solutions.

The third detachable vertical optical coupler 700 includes a PIC 740 and an FAU 750. The PIC 740 includes a support structure 102 and an optical layer 760 similar to the optical layers 160, 360, and 560. The optical layer 760 includes an array of reflectors, e.g., the reflector 725, which is similar to the reflectors 325 and 525. The PIC 740 further includes a lens array layer 710 bonded over the optical layer 760. The lens array layer 710 includes a reflective lens 715 that is offset from the reflector 725. An optical path from the reflector 725 passes through an upper surface of the 710 without passing through the reflective lens 715. Furthermore, unlike the lenses 315 and 515, which were convex, the reflective lens 715 is concave, e.g., the reflective lens 715 is a concave mirror.

On the FAU 750, an array of symmetric curved mirror structures, such as the reflective lens 717, are fabricated on the monolithic housing. The reflective lens 717 is within a cavity 720 formed in a bulk material for forming the FAU 750 (here, the housing material 108). The cavity 720 and reflective lens 717 may be along a front side of the FAU 750, where the front side can be detachably coupled to the PIC 740.

The cavity 720 has a height 721, which corresponds to a distance 721 between the reflective lens 715 and the reflective lens 717. The height 721 of the cavity may be, e.g., between 10 and 50 μm. Like the reflective lens 715, the reflective lens 717 is a concave mirror, so that the shape of the reflective lens 717 extends into the housing material 108. For example, the shape of the reflective lens 717 may be formed subtractively from a glass housing material 108 by removing a first portion of the glass to form the cavity 720, and removing an additional portion of the glass to shape the reflective lens 717. Alternatively, the housing material 108 may be a polymer, and the cavity 720 and shape of the reflective lens 717 may be printed in the polymer. The reflective lens 717 is arranged to deflect light away from the FAU 750 and back towards the PIC 740, and in particular, towards the reflective lens 715.

The design of third detachable vertical optical coupler 700 with the pair of reflective lenses 715 and 717 aims to direct the light path from the PIC 740 to reflect multiple times before coupling into the fiber 735 on the FAU 750. An end of the optical fiber 735 (e.g., an input to the optical fiber 735) is at a different portion of the cavity 720, offset from the reflective lens 717 in the x-direction. The FAU 750 includes monolithic fiber housing that may be fabricated with 2D ferrule arrays to guide the optical fibers 735 and bend their directions vertically, e.g., as described with respect to FIG. 1.

The multi-reflection design helps improve alignment tolerance and coupling efficiency by effectively managing the optical path within the connector structure. When an in-plane offset (e.g., offset in the x-direction) occurs between the pair of reflective lenses 715 and 717, the consequential offset on the first reflective lens 715 generates an exact but opposite offset on the second reflective lens 717, i.e., the symmetrical double-concave mirrors compensate each other in planar offsets. This self-locking coupler improves tolerance for lateral offset by at least two times compared to other expanded beam based couplers.

Furthermore, tilt alignment between the PIC 740 and FAU 750 (e.g., rotation within the x-z plane) can also be accurately controlled by co-planar contact between the lens array layer 710 and the bottom surface of the FAU 750 with very tight surface flatness tolerance. Therefore, based on the self-locking mechanism between the PIC 740 and FAU 750, the lateral offset tolerance can be substantially improved without further expanding the beam size, and thus can serve as a detachable user interface. Additionally, if HRC is applied to the reflective surfaces (i.e., the reflector 725, reflective lens 715, and reflective lens 717), there may be a total reflection loss of less than 0.1 dB in this light path; this is because HRC efficiency is typically achievable at 99% or higher. Overall, the third detachable vertical optical coupler 700 permit an alignment error between a transmitting assembly (e.g., the PIC 740) and a receiving assembly (e.g., the FAU 750) of at least 100 μm with a coupling loss of less than −1 dB.

In some embodiments, the reflective lens 715 and reflective lens 717 have spherical shapes. In other embodiments, the reflective lens 715 and reflective lens 717 have toric shapes. Using toric lenses can increase the offset tolerance in the detachable assembly process. To maintain a low incidence angle to the reflective lens 717, the horizontal distance between the reflective lens 717 and the reflector 725 is to be minimized. This is because for a curved mirror, a large incidence angle will lead to distortions in beam shape, which can result in a high coupling loss due to beam mismatch. Consequently, a small diameter of the reflective lens 717 prevents the reflective lens 717 and reflector 725 from blocking the optical path. However, this limitation on lens diameter limits the offset tolerance, due to the aperture effect of the curved mirror. To overcome this challenge, a toric lens, which a type of non-axial-symmetric lens with different Radius of Curvature (ROC) along two orthogonal axes, can be used. The reflective lens 715 may have a corresponding toric shape. The toric lenses may have a greater ROC in the x-direction (e.g., the direction between the reflective lens 717 and the end of the optical fiber 735) than in the y-direction. The toric lens shaped is designed to compensate for beam distortion with larger incidence angles, thereby removing the limitations on lens diameter by spherical lenses.

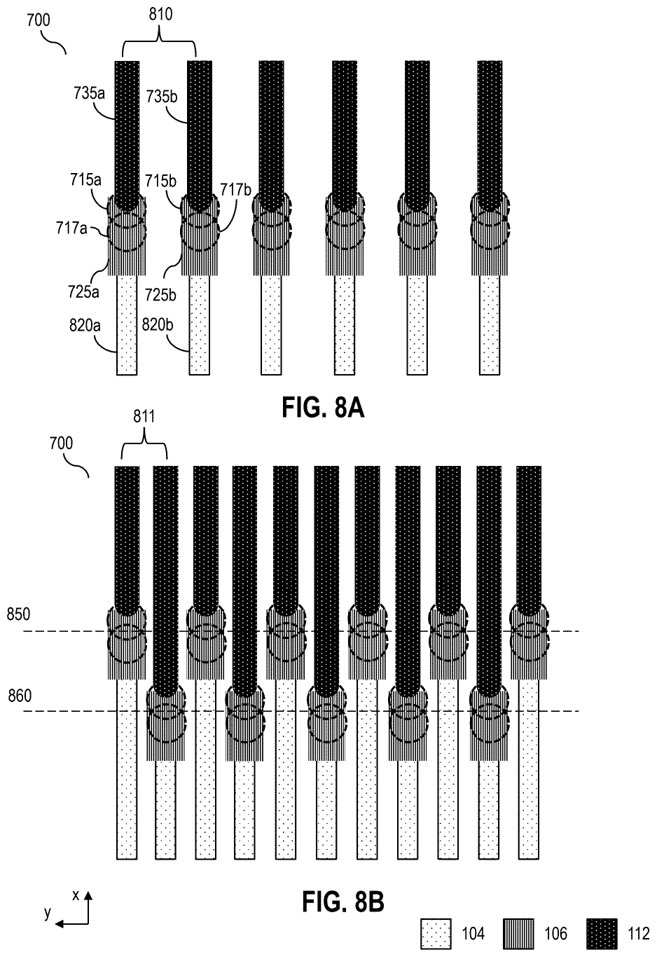

FIG. 8A illustrates a first example top view of the third vertical optical coupler 700 of FIG. 7, according to various embodiments. FIG. 8A illustrates six optical pathways, each of which includes a waveguide 820 formed in the optical material 104, a reflector 725, a reflective lens 717, a reflective lens 715, and an optical fiber 735. For example, a first optical pathway including waveguide 720a, reflector 725a, reflective lens 717a, reflective lens 715a, and optical fiber 735a may be a top view of the optical pathway illustrated in FIG. 7. To aid in illustration, the housing material 108, bonding material 110, and material of the lens array layer 710 (other than the outlines of the lenses 717 and 715) are not shown. As another example, the second optical pathway includes waveguide 720b, reflector 725b, reflective lens 717b, reflective lens 715b, and optical fiber 735b. The optical pathways extend parallel to each other and at a pitch of 810. The pitch 810 may be, e.g., between 50-250 μm.

In some embodiments, stacks of reflectors and reflective lenses be staggered, e.g., as shown in the example of FIG. 8B. FIG. 8B illustrates an alternate top view of the optical interfaces which may be included in the vertical optical coupler 700. In FIG. 8A, the reflectors and lenses are generally arranged along a single line, e.g., with each of the lenses 717 along a single line, and each of the lenses 715 arranged along another line slightly offset from the lenses 717. In FIG. 8B, stacks of reflectors and reflective lenses are generally arranged along two lines 850 and 860, or two arrays, that are parallel to each other and offset from each other, e.g., at different positions along the x-direction. Each of the arrays 850 and 860 extend along the y-direction, which is perpendicular to the incoming path of the optical beam towards the reflector 725 (i.e., the x-direction). Staggering the reflectors, lenses, and curved mirrors in this way may allow a tighter pitch 811 (e.g., between 25 and 125 μm) between adjacent optical pathways relative to the arrangement of FIG. 8A.

Each of the embodiments shown in FIGS. 1-8 includes a reflector 125, 325, 525, or 725 formed in an optical layer 160, 360, 560, or 760. Different reflector designs and corresponding processing techniques may be used to form an angled reflective surface, or sloped mirror, within an optical layer.

FIGS. 9A, 9B, 9C, and 9D illustrate cross-sectional views of four example implementations of angled reflective surfaces for use in any of the embodiments of FIGS. 1-8. Each of the examples of FIGS. 9A-9D includes an optical channel 902, e.g., a waveguide, formed within the optical material 104. The optical channel 902 is directed along the x-direction towards a sloped mirror 106 having a reflective surface. In FIG. 9A, an embedded mirror 910 in the optical layer may have a parallelogram cross-section, with a reflective surface 911 and a second surface 912 parallel to the reflective surface 911. The embedded mirror 910 may be formed on a wafer by slanting the wafer and etching the opening for the embedded mirror 910, e.g., using dry etching. The interior of the 910 (between the reflective surface 911 and second surface 912 may be air, and a cap (e.g., silicon oxide) may be deposited over the etched opening to seal the air gap between the reflective surface 911 and the second surface 912. For example, a silicon oxide cap may be present at a top 913 of the embedded mirror 910 or at the base 914 of the embedded mirror 910, depending on the direction from which the embedded mirror 910 was etched.

In other embodiments, a reflective material, such as aluminum, may be deposited within the opening. The reflective material may completely fill the opening or line the walls (e.g., the reflective surface 911 and second surface 912) of the opening. The reflective material may be deposited using a conformal deposition process. For example, atomic layer deposition (ALD) or chemical vapor deposition (CVD) may be used. Conformal deposition generally refers to deposition of a certain coating on any exposed surface of a given structure. A conformal coating may, therefore, be understood as a coating that is applied to exposed surfaces of a given structure, and not, for example, just to the horizontal surfaces.

In some cases, if the distance between the reflective surface 911 and second surface 912 is relatively small, it may be challenging to deposit the reflective material into the opening. In some cases, an enlarged opening may be formed and filled, e.g., as shown in FIG. 9B. In FIG. 9B, an embedded mirror 920 has a trapezoidal shape with a reflective surface 921 similar to the reflective surface 911 and a second surface 922 that is not parallel to the reflective surface 921, but instead, is oriented vertically. The reflective surface 921 may be formed by etching a slanted wafer, as described with respect to FIG. 9A. An additional etching process may be performed on an unslanted wafer (i.e., a standard horizontal orientation for wafer processing) to widen the opening, resulting in the second surface 912. The slanted etching and the horizontal etching processes may be performed in either order. After etching the opening, the opening is filled with a reflective material, resulting in the embedded mirror 920 with the reflective surface 921, the second surface 922, a top 923, and a bottom 924. The second surface 922 is perpendicular to the top 923 and bottom 924. A first angle between the top 923 and the reflective surface 921 may be substantially the same as a second angle between the top 923 and the second surface 922, e.g., the first angle may be within 5%, within 10%, within 15%, or within 20% of the second angle, or the first angle may be within 5°, within 10°, within 15°, or within 20° of the second angle.

FIG. 9C shows another embodiment of an embedded mirror 930 that has a trapezoidal shape with a reflective surface 931 and a second surface 932 that extends at the same angle as the reflective surface 931 from the top 933. The shape of the trapezoidal embedded mirror 930 may be formed in a single etching process, where the etch process is controlled to result in the slanted surfaces 931 and 932. As with the embedded mirror 910, the embedded mirror 930 may be filled with a reflective material or filled with air and capped.

In each of FIGS. 9A-9C, the optical layer includes a first layer with the optical channel 902 and the embedded mirror 910, 920, or 930, and a second layer of the optical material 104 below the first layer. In such cases, the embedded mirror and optical channel 902 may be formed from the bottom side (in the orientation shown) of the first layer, and the second layer of the optical material 104 may then be bonded to the bottom side of the first layer. The optical channel 902 may be a waveguide, and the bottom layer may act as cladding for the lower side of the waveguide.

In other embodiments, such as the example of FIG. 9D, the embedded mirror may be formed after the second layer is bonded below the first layer that includes the optical channel 902. In FIG. 9D, the embedded mirror 940 has a similar shape to the embedded mirror 930, but a different position from the embedded mirror 930. In this example, the top 943 of the embedded mirror 940 is below a top surface of the upper optical layer. In the examples of FIGS. 9A-9C, the tops of the embedded mirrors may also be below the top surface of the upper optical layers. Furthermore, for FIG. 9D, the top 943 may be coplanar with the top of the upper optical layer, e.g., as shown in FIG. 9C.

In the example of FIG. 9D, the bottom 944 of the embedded mirror 940 is along a bottom of the lower optical layer. Any of the embedded mirrors 910, 920, and 930 may extend through the lower optical layers and have bottoms along the lower optical layers if they are formed after the lower optical layer is bonded to the upper optical layer.

In FIG. 9D, a reflective material forming the mirror 106 is deposited along the reflective surface 941, second surface 942, and top 943 of the embedded mirror 940, forming a first layer of the embedded mirror 940. A fill material 904 is then deposited within the remaining opening, forming a second layer or fill layer of the embedded mirror 940. In this example, the fill material 904 extends along the bottom 944 of the embedded mirror 940. In other embodiments, another layer of the reflective material is deposited over the fill material 904, so that in the cross-section, the reflective material forms all 4 sides of the trapezoidal shape of the embedded mirror 940.

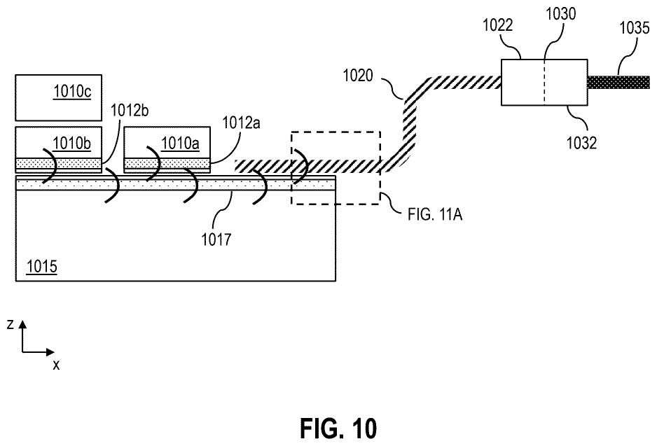

FIGS. 10-15 illustrate additional embodiments of optical interfaces that rely on evanescent coupling to transfer optical signals. Evanescent coupling refers to the transfer of light between two waveguides or optical fibers that are in close proximity, without physical contact. The transfer occurs through the evanescent wave, which is the exponentially decaying electromagnetic field that extends beyond the core of a waveguide. When two waveguides are sufficiently close, their evanescent fields interact, allowing energy to be transferred from one waveguide to another. The strength of this coupling depends on the distance between the waveguides and the overlap of their modes. If the waveguides are very close, the coupling can be very strong, but if they are farther apart, the coupling weakens quickly due to the exponential decay of the evanescent wave.

FIGS. 10-12 illustrate an embodiment of a bridge-based optical coupler based on evanescent coupling. The bridge is a pitch-converting interposer that bridges an optical fiber and PIC waveguides. FIG. 10 is a side view that includes a bridge 1015 and a soft coupler 1020. The soft coupler 1020 is coupled to an optical fiber 1035 by a fiber connection 1030, which may be detachable. Multiple PICs 1010 are arranged over the bridge 1015. The PICs 1010 may include optical waveguides, e.g., as described with respect to FIG. 1. Waveguides in the PICs 1010a and 1010b (e.g., waveguides 1012a and 1012b, respectively) are coupled to waveguides (e.g., waveguide 1017) in the bridge 1015 by evanescent coupling, as indicated by the wave fronts within and extending outside of the waveguides 1012 and 1017. Additional ICs, e.g., the PIC 1010c, may be stacked over the bridge 1015 and/or one or more of the PICs 1010a and 1010b. In this example, the PIC 1010c is stacked over the PIC 1010b.

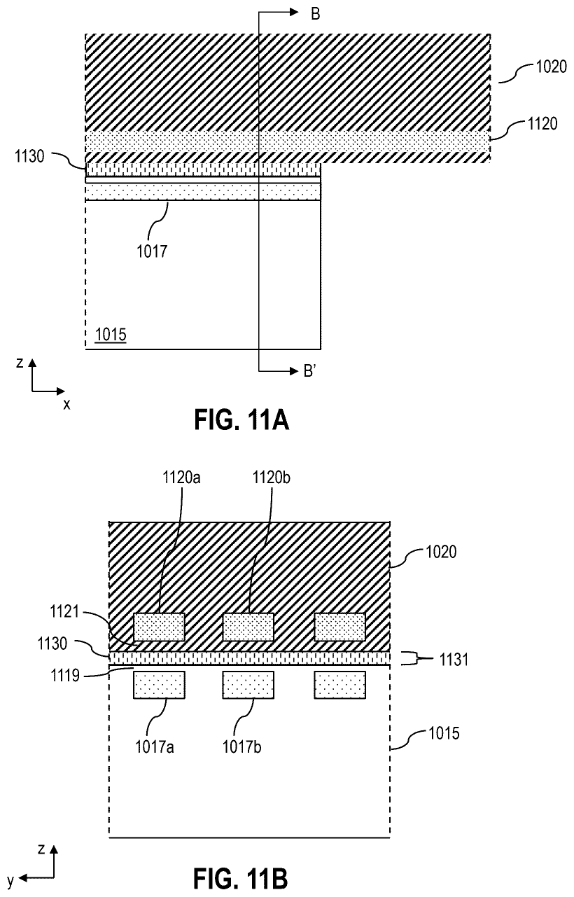

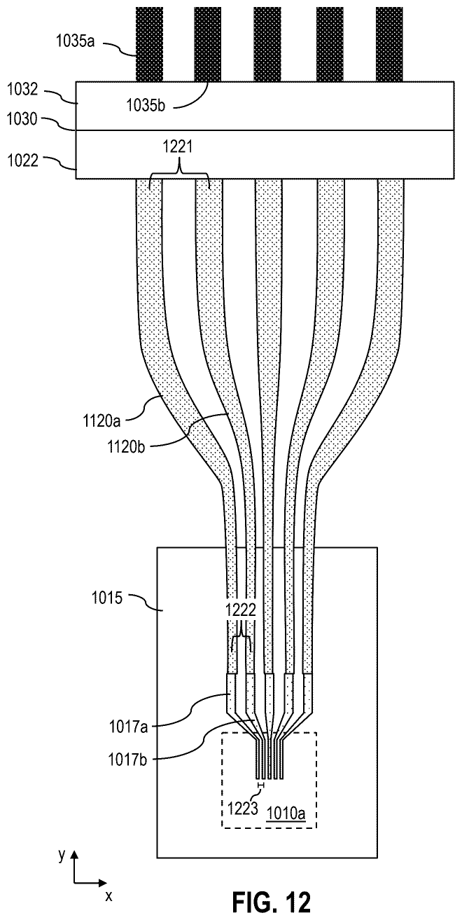

The waveguides in the bridge 1015 are coupled to waveguides in the soft coupler 1020 by evanescent coupling. FIG. 11A illustrates the interface between the bridge 1015 and the soft coupler 1020 in more detail, and FIG. 11B is a cross-section through the plane BB′ of FIG. 11A. FIG. 12 illustrates a top view of the coupler shown in FIG. 10.

The soft coupler 1020 may include multiple soft waveguides on a soft substrate. Soft substrates may include, for example, polymer, plastic, soft glass, organic crystal, hydrogels, or other soft optical materials. Strip waveguides, which may be made from the same type of soft material but with a higher refractive index, can be patterned on the soft substrate using lithography to function as waveguide core. The waveguide core is covered by soft materials (e.g., the same types of soft optical materials as the soft substrate) as a cladding layer, forming a flexible, soft waveguide coupler. By designing bent waveguide patterns in the soft coupler, pitch scaling can be achieved to reduce the channel distance between adjacent waveguides from around 250 μm (in typical fiber connector) at a first end 1022 to down to around 50 μm at the bridge 1015. FIG. 12 provides a top view illustrating the pitch scaling within the soft coupler 1020. A first pitch 1221 between adjacent waveguides 1120a and 1120b entering the fiber connection 1030 is greater (e.g., at least two times greater, at least three times greater, at least four times greater, or at least five times greater) than a second pitch 1222 between adjacent waveguides 1120a and 1120b over the bridge 1015. The optical fibers 1035 extending out of the fiber connection 1030 may have the pitch 1221 of the waveguides 1120 entering the fiber connection 1030.

For optical coupling between the PIC 1010 and fiber connection 1030, different approaches are used on each side of the soft coupler 1020 to accommodate the form factor difference between them. On the fiber side, a detachable fiber connection 1030 can be achieved using pin-hole alignment and physical contact, similar to a Mechanical Transfer (MT) fiber connector. The fiber connection 1030 includes a first end 1022 coupled to the waveguides 1120 and a second end 1032 coupled to the optical fibers 1035. This fiber connection 1030 can achieve 3-sigma loss of <0.4 dB, in some embodiments. Secondly, on the optical bridge side, to accommodate the small form factor after pitch scaling, the waveguides of the soft coupler 1020 are coupled to waveguides (e.g., waveguide 1017) within the bridge 1015 by evanescent coupling (EVC). EVC is a vertical coupling mechanism that allows direct optical signal transition between two parallel optical waveguides positioned close enough to each other. Compared to edge coupling, EVC has a much smaller form factor due to its vertical stack structures through bonding techniques, making it highly suitable for high density waveguides.

A significant challenge of conventional EVC is the control of the bonding layer thickness (BLT) at the interface between the bridge 1015 and the soft coupler 1020. A bonding layer 1130 with a thickness 1131 is shown in FIGS. 11A and 11B. Typically, EVC is possible with a BLT of less than 1 μm or less than 2 μm. This thickness can be difficult to achieve across a large bonding area. Soft waveguides enable a low BLT across a large bonding area. Unlike conventional EVC, which is typically implemented with glass-based couplers, soft couplers are insensitive to warpage and tilting effects as they can conform to surface topography. This results in significantly better coupling loss reduction and higher warpage resistance, thereby enhancing stability of the package.

However, for soft waveguide couplers, as well as conventional glass couplers, reducing the pitch dimension below around 50 μm remains challenging. This is because the dimensions of these waveguides are still significantly larger than those of PIC waveguides due to the small refractive index contrast. To address this challenge, the soft coupler 1020 is connected to the bridge 1015, e.g., which includes surface waveguides on a Silicon-On-Insulator (SOI) or glass substrate. The bridge 1015 facilitates a second stage of pitch scaling prior to the PICs 1010. The bridge 1015 scales the pitch between adjacent channels from the pitch 1222, where the waveguides 1120 are coupled to the waveguides 1017 (e.g., waveguides 1017a and 1017b), to a smaller pitch 1223, where the waveguides 1017 are evanescently coupled to waveguides 1012 in the PICs 1010a and/or 1010b. In some embodiments, the pitch 1223 is less than 10 μm or less than 5 μm. The pitch 1222 may be, e.g., at least two times greater, at least three times greater, at least four times greater, at least five times greater, or at least ten times greater than the pitch 1223. The pitch scaling within the bridge 1015 and the soft coupler 1020 can increase the maximum channel density available on the PIC compared to prior optical couplers.

Specifically, the optical interface shown in FIGS. 10-12 includes an optical bridge 1015 that includes a first pair of waveguides 1017a and 1017b that are at a first surface (e.g., an upper surface) of the optical bridge. An upper surface of the waveguides 1017 may be directly on the upper surface or the bridge 1015, or a thin cladding layer may be over the upper surface of the waveguides 1017, e.g., the cladding 1119 shown in FIGS. 11A and 11B. The waveguides 1017 are arranged at a first pitch 1222 at one portion of the bridge 1015 and a second pitch 1223 at another portion of the optical bridge; the first pitch 1222 is greater than the second pitch 1223. The first pitch 1222 may be, e.g., between 20 and 100 μm. The second pitch 1223 may be, e.g., less than 20 μm, less than 10 μm, or less than 5 μm.

A second pair of waveguides 1120a and 1120b are arranged over the first pair of waveguides 1017a and 1017b, respectively, at the first portion of the optical bridge 1015, and, in this region, the second pair of waveguides 1120a and 1120b are arranged at the first pitch 1222. The second pair of waveguides 1120a and 1120b have a third pitch 1221 at a portion not over the optical bridge 1015, and the third pitch 1221 is greater than the first pitch 1222. A third pair of waveguides, e.g., the waveguide 1012a and a second, parallel waveguide in the PIC 1010a, are arranged over the first pair of waveguides 1017a and 1017b at the second portion of the optical bridge 1015. The third pair of waveguides are arranged at the second pitch 1023. The waveguides 1017 in the optical bridge 1015 communicatively couple the waveguides 1120 in the soft coupler 1020 to waveguides 1012 in a PIC 1010, e.g., to the waveguide 1012a in the PIC 1010a.

A distance between waveguides 1017 and waveguides 1012 (specifically, between a waveguide 1017 and a waveguide 1012 directly over the waveguide 1017) may be less than 10 μm, less than 5 μm, less than 3 μm, less than 2 μm, or less than 1 μm. A distance between waveguides 1017 and waveguides 1120 (specifically, between a waveguide 1017 and a waveguide 1120 directly over the waveguide 1017) may be less than 10 μm, less than 5 μm, less than 3 μm, less than 2 μm, or less than 1 μm. For example, a thickness of the bonding layer 1130 may be less than 10 μm, less than 5 μm, less than 3 μm, less than 2 μm, or less than 1 μm. Likewise, a thickness of a bonding layer between the PICs 1010 and the bridge 1015 may be less than 10 μm, less than 5 μm, less than 3 μm, less than 2 μm, or less than 1 μm.

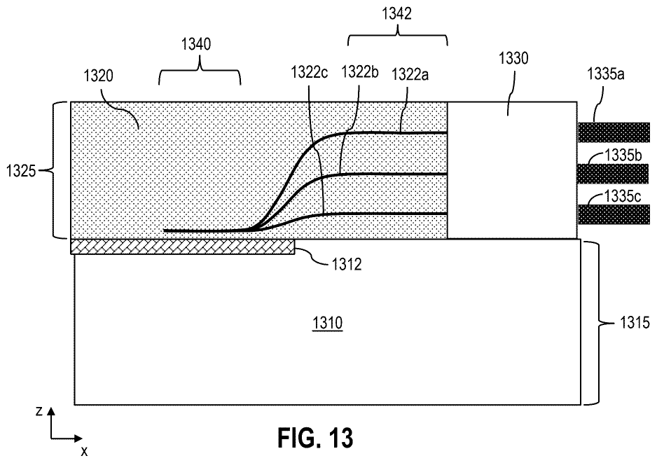

FIGS. 13-15 illustrate another optical coupling structure that relies on evanescent coupling to transfer optical signals. In FIG. 13, a 3D waveguide structure 1320 is bonded to a PIC 1310. The 3D waveguide structure 1320 may be attached to the PIC 1310 at the wafer level, enabling high precision. For example, hybrid bonding can enable sub-10-μm bonding pitch. The PIC 1310 includes waveguides, such as the waveguide 1312 shown in FIG. 13. The waveguide 1312 may be similar to the waveguides described with respect to FIG. 1. The waveguide 1312 is along an upper surface of the PIC 1310. In some embodiments, a thin layer of cladding may be over the top of the waveguide 1312, e.g., as described with respect to FIG. 11. The PIC 1310, including the waveguide 1312, are within a first layer 1315 of the assembly.

The 3D waveguide structure 1320 includes waveguides 1322a, 1322b, and 1322c. In a first region 1340 of the 3D waveguide structure 1320, the waveguides 1322 extend along a lower surface of the 3D waveguide structure 1320, directly over corresponding waveguides in the PIC 1310. In this region 1340, evanescent coupling is used to communicate optical signals between the waveguides 1312 and 1322. The waveguides 1322 are arranged within the 3D waveguide structure 1320 to convert a 2D array of channels (in the region 1340) to a 3D array, with multiple stacked waveguides; the waveguides 1322 are stacked within a second region 1342 of the 3D waveguide structure 1320.

The 3D waveguide structure 1320 may be formed from a glass wafer, and the waveguides 1322 may be formed within the glass wafer using laser direct writing. Glass wafers are available in a large range of thicknesses and sizes, which can accommodate a large number of waveguides. In addition, glass offers a range of coefficients of thermal expansion (CTE), and glass with a CTE close to that of silicon (if the PIC 1310 is silicon-based) can eliminate or reduce thermal stress through thermal cycling experience in assembly processes and operations. Laser-scribed waveguides offer design flexibility, such as pitch conversion, fanouts in height and width directions, waveguide cross section transition, etc. In some embodiments, the laser-scribed waveguides are formed at the wafer level, the glass wafer is diced, and then an individuated glass die including the waveguides 1322 is bonded to the PIC 1310.

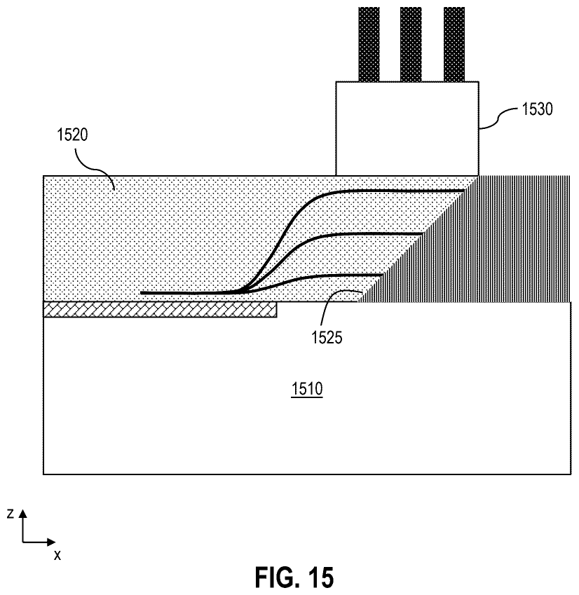

The 3D waveguide structure 1320 is coupled to optical fibers 1335 by a fiber connection 1330, which may be detachable. The fiber connection 1330 provides an output from the PIC 1310 and 3D waveguide structure 1320. The 3D arrangement of the waveguides 1322 in the second region 1342 is mirrored in the arrangement of the optical fibers 1335. For example, the fiber connection 1330 couples the waveguide 1222a to the optical fiber 1335a, the waveguide 1222b to the optical fiber 1335b, and the waveguide 1222c to the optical fiber 1335c. In this example, the fiber connection 1330 is within the same layer 1325 as the 3D waveguide structure 1320. In the example shown in FIG. 15, a fiber connection is over the 3D waveguide structure.

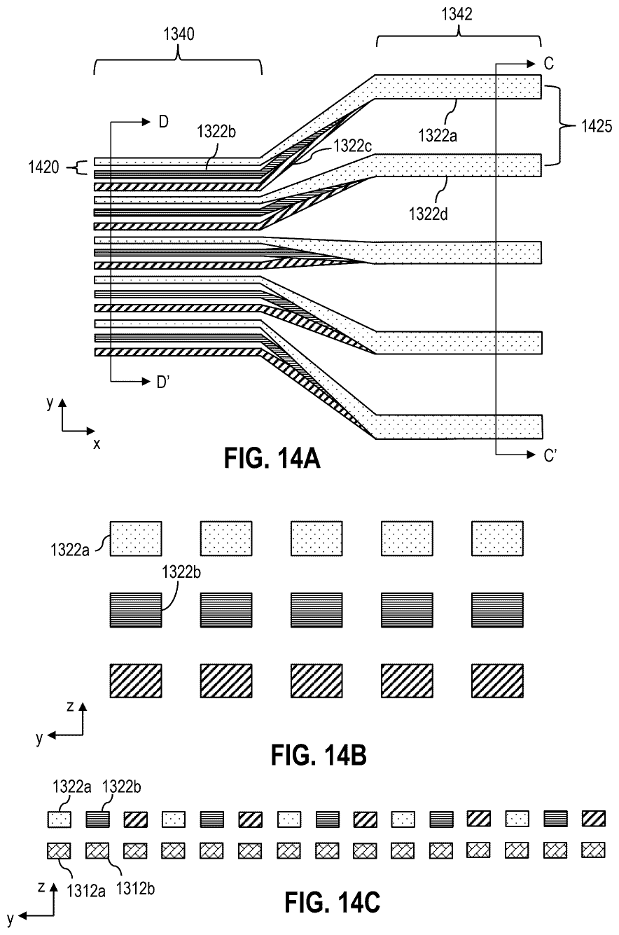

The 3D waveguide structure 1320 enables the connection interface between the PIC 1310 and the optical fibers 1335 to be scaled up to a 2-D array. The 3D waveguide structure 1320 may also provide pitch scaling, increasing a pitch between adjacent waveguides 1322 moving from the PIC 1310 to the optical fibers 1335. FIG. 14A is an example detailed top view of the waveguides 1322, illustrating the pitch scaling. In the first region 1340, a pair of adjacent waveguides in the y-direction (e.g., waveguides 1322a and 1322b) have a first pitch 1420. In the second region 1342, a pair of adjacent waveguides in the y-direction (e.g., waveguides 1322a and 1322d) have a second pitch 1425, where the second pitch 1425 is greater than the first pitch 1420. For example, the first pitch 1420 may be, e.g., less than 50 μm, less than 40 μm, less than 30 μm, or less than 20 μm. The second pitch 1425 may be, e.g., greater than 50 μm or greater than 100 μm.

FIGS. 14B and 14C are two cross-section views of the waveguides of FIG. 14A, according to some various embodiments. FIG. 14B is a cross-section through the plane CC′ in FIG. 14A, and FIG. 14C is a cross-section through the plane DD′ in FIG. 14A. FIGS. 14B and 14C show that an array of waveguides, e.g., a single array of 15 waveguides, are transitioned to a matrix, e.g., a 3×5 matrix of waveguides.

In the region 1340, each of the waveguides 1322 is over a respective one of the waveguides 1312 in the PIC. For example, as shown in FIG. 14C, the waveguide 1322a is over the waveguide 1312a in the PIC 1310, and the waveguide 1322b is over the waveguide 1312b in the PIC. In this region 1340, to enable evanescent coupling, a distance between waveguides 1312 and waveguides 1322 (e.g., between a waveguide 1312a and a waveguide 1322a directly over the waveguide 1312a) may be less than 5 μm, less than 3 μm, less than 2 μm, or less than 1 μm. In the region 1345, a portion of the waveguides 1322 are over other ones of the waveguides 1322. For example, in FIG. 14B, the waveguide 1322a is over the waveguide 1322b. The waveguide 1322a is farther from the first layer 1315 than the waveguide 1322b.

FIG. 15 illustrates an embodiment in which the fiber connection 1530 is over the 3D waveguide structure 1520. In this example, the 3D waveguide structure 1520 includes a reflector 1525, which may be similar to the reflector 325 or other reflectors described with respect to FIGS. 1-9. The reflector 1525 reflects optical signals traveling in the x-direction into the z-direction and into the fiber connection 1530, which is connected to an array of optical fibers in a similar manner to the fiber connection 1330. The fiber connection 1530 may be detachable.

Arrangements with one or more optical couplers as disclosed herein may be included in any suitable component or electronic device. FIGS. 9-11 illustrate various examples of devices and components that may include one or more optical couplers as disclosed herein.

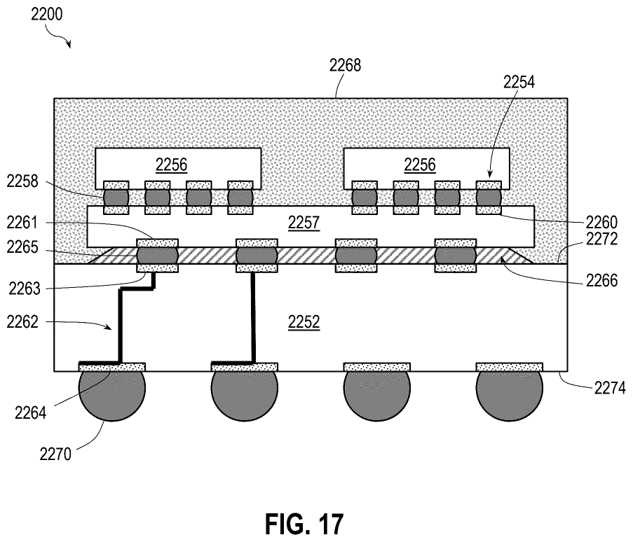

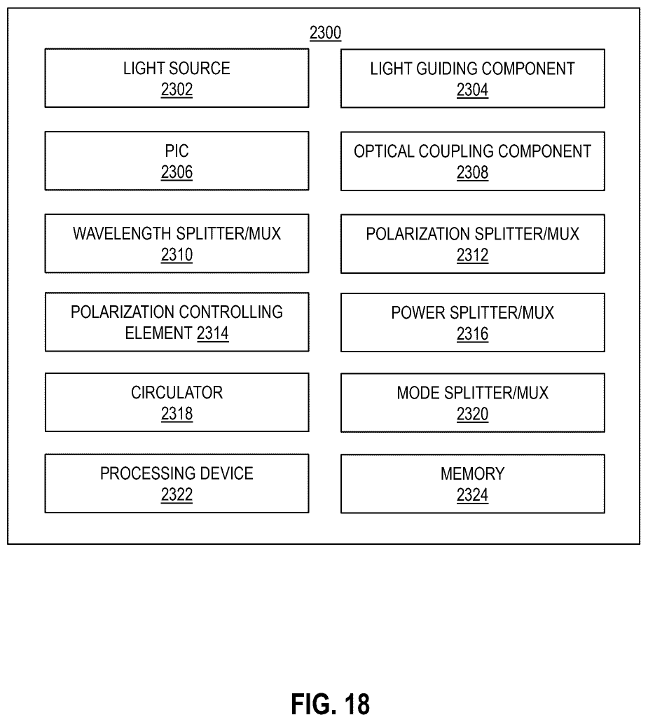

FIG. 16 illustrates top views of a wafer 2100 and dies 2102 that may include or be used in conjunction with one or more optical couplers in accordance with any of the embodiments disclosed herein. In some embodiments, the dies 2102 may be included in an IC package, in accordance with any of the embodiments disclosed herein. For example, any of the dies 2102 may serve as any of the dies 2256 in an IC package 2200 shown in FIG. 17. The wafer 2100 may be composed of semiconductor material and may include one or more dies 2102 having IC structures formed on a surface of the wafer 2100. Each of the dies 2102 may be a repeating unit of a semiconductor product that includes any suitable IC (e.g., ICs including one or more photonic integrated circuits (PICs) as described herein, e.g., the PIC 2306 of FIG. 18). At least some of the dies 2102 may further include or be coupled to one or more optical couplers implemented on, or attached to the die 2102. After the fabrication of the semiconductor product is complete (e.g., after manufacture of any embodiment of the optical couplers as disclosed herein), the wafer 2100 may undergo a singulation process in which each of the dies 2102 is separated from one another to provide discrete “chips” of the semiconductor product. In particular, devices that include one or more optical couplers as disclosed herein may take the form of the wafer 2100 (e.g., not singulated) or the form of the die 2102 (e.g., singulated). The die 2102 may include supporting circuitry to route electrical and/or optical signals to various components, e.g., to various optical couplers, as well as to various transistors, capacitors, resistors, or any other IC components.

FIG. 17 is a side, cross-sectional view of an example microelectronic package 2200 that may include one or more optical couplers in accordance with any of the embodiments disclosed herein. In some embodiments, the microelectronic package 2200 may be a system-in-package (SiP).

The package substrate 2252 may be formed of a dielectric material (e.g., a ceramic, a buildup film, an epoxy film having filler particles therein, etc.), and may have conductive pathways 2262 extending through the dielectric material between the face 2272 and the face 2274, or between different locations on the face 2272, and/or between different locations on the face 2274.

The package substrate 2252 may include conductive contacts 2263 that are coupled to conductive pathways 2262 through the package substrate 2252, allowing circuitry within the dies 2256 and/or the interposer 2257 to electrically couple to various ones of the conductive contacts 2264 (or to other devices included in the package substrate 2252, not shown).

The microelectronic package 2200 may include an interposer 2257 coupled to the package substrate 2252 via conductive contacts 2261 of the interposer 2257, first-level interconnects 2265, and the conductive contacts 2263 of the package substrate 2252. The first-level interconnects 2265 illustrated in FIG. 17 are solder bumps, but any suitable first-level interconnects 2265 may be used. In some embodiments, no interposer 2257 may be included in the microelectronic package 2200; instead, the dies 2256 may be coupled directly to the conductive contacts 2263 at the face 2272 by first-level interconnects 2265.

The microelectronic package 2200 may include one or more dies 2256 coupled to the interposer 2257 via conductive contacts 2254 of the dies 2256, first-level interconnects 2258, and conductive contacts 2260 of the interposer 2257. The conductive contacts 2260 may be coupled to conductive pathways (not shown) through the interposer 2257, allowing circuitry within the dies 2256 to electrically couple to various ones of the conductive contacts 2261 (or to other devices included in the interposer 2257, not shown). The first-level interconnects 2258 illustrated in FIG. 17 are solder bumps, but any suitable first-level interconnects 2258 may be used. As used herein, a “conductive contact” may refer to a portion of electrically conductive material (e.g., metal) serving as an interface between different components; conductive contacts may be recessed in, flush with, or extending away from a surface of a component, and may take any suitable form (e.g., a conductive pad or socket).

In some embodiments, an underfill material 2266 may be disposed between the package substrate 2252 and the interposer 2257 around the first-level interconnects 2265, and a mold compound 2268 may be disposed around the dies 2256 and the interposer 2257 and in contact with the package substrate 2252. In some embodiments, the underfill material 2266 may be the same as the mold compound 2268. Example materials that may be used for the underfill material 2266 and the mold compound 2268 are epoxy mold materials, as suitable. Second-level interconnects 2270 may be coupled to the conductive contacts 2264. The second-level interconnects 2270 illustrated in FIG. 17 are solder balls (e.g., for a ball grid array arrangement), but any suitable second-level interconnects 22770 may be used (e.g., pins in a pin grid array arrangement or lands in a land grid array arrangement). The second-level interconnects 2270 may be used to couple the microelectronic package 2200 to another component, such as a circuit board (e.g., a motherboard), an interposer, or another IC package, as known in the art.

The dies 2256 may take the form of any of the embodiments of the die 2102 discussed herein (e.g., may include any of the embodiments of the IC devices implementing optical couplers as disclosed herein). In embodiments in which the microelectronic package 2200 includes multiple dies 2256, the microelectronic package 2200 may be referred to as a multi-chip package (MCP). The dies 2256 may include circuitry to perform any desired functionality. In some embodiments, any of the dies 2256 may include one or more optical couplers as discussed above.

The microelectronic package 2200 illustrated in FIG. 17 may be a flip chip package, although other package architectures may be used. For example, the microelectronic package 2200 may be a ball grid array (BGA) package, such as an embedded wafer-level ball grid array (eWLB) package. In another example, the microelectronic package 2200 may be a wafer-level chip scale package (WLCSP) or a panel fan-out (FO) package. Although two dies 2256 are illustrated in the microelectronic package 2200 of FIG. 17, an IC package 2200 may include any desired number of the dies 2256. An IC package 2200 may include additional passive components, such as surface-mount resistors, capacitors, and inductors disposed on the first face 2272 or the second face 2274 of the package substrate 2252, or on either face of the interposer 2257. More generally, an IC package 2200 may include any other active or passive components known in the art.

FIG. 18 is a block diagram of an example photonic device 2300 that may include one or more components in which the optical couplers as disclosed herein may be implemented. For example, any suitable ones of the components of the photonic device 2300 may include a die (e.g., the die 2102 of FIG. 16) having one or more microelectronic packages (e.g., microelectronic packages 2200 of FIG. 17).

A number of components are illustrated in FIG. 18 as included in the photonic device 2300, but any one or more of these components may be omitted or duplicated, as suitable for the application. In some embodiments, some or all of the components included in the photonic device 2300 may be attached to one or more motherboards or any suitable support structure. In some embodiments, some or all of these components are fabricated onto a single system-on-chip (SoC) die. Additionally, in various embodiments, the photonic device 2300 may not include one or more of the components illustrated in FIG. 18, but the photonic device 2300 may include interface circuitry for coupling to the one or more components. For example, the photonic device 2300 may not include a processing device 2322, but may include processing device interface circuitry (e.g., a connector and driver circuitry) to which a processing device 2322 may be coupled. In another example, the photonic device 2300 may not include a memory 2324, but may include memory interface circuitry (e.g., connectors and supporting circuitry) to which a memory 2324 may be coupled. In yet another example, the photonic device 2300 may not include a circulator 2318, but may include circulator interface circuitry (e.g., connectors) to which a circulator 2318 may be coupled

In some embodiments, the photonic device 2300 may include at least one light source 2302. The light source 2302 may include any suitable device for providing the necessary optical signals for various applications of the photonic device 2300, ranging from communication to sensing and imaging. The light source 2302 may be designed to emit light in a controlled and efficient manner to meet the specific requirements of the photonic device 2300. In some embodiment, the light source 2302 may be a coherent and monochromatic light source such as a laser, to produce light of a well-defined wavelength, low divergence, and high brightness. Examples of lasers that may be included in the light source 2302 include semiconductor lasers, such as edge-emitting lasers and vertical-cavity surface-emitting lasers (VCSELs). Such lasers may be particularly advantageous when the photonic device 2300 is used in applications like optical communication, sensing, and laser-based treatments in medical devices. In some embodiment, the light source 2302 may be a non-coherent light source such as an LED that emits light when an electric current is applied. LEDs may be simpler and more cost-effective than lasers, making them suitable for applications where high coherence is not required. Using an LED as the light source 2302 may be particularly advantageous when the photonic device 2300 is used in applications like displays, optical sensors, and short-distance communication systems. In further embodiments, the light source 2302 may include one or more of a superluminescent diode (SLD), a quantum dot, a rare-earth-doped fiber/waveguide, a plasma source (e.g., plasmonics and microplasma devices), a microcavity resonators, or a nonlinear optical device (e.g., a photonic device that uses nonlinear optical processes, such as frequency doubling or parametric amplification, to generate new wavelengths).

In some embodiments, the photonic device 2300 may include at least one light guiding component 2304, such as a waveguide, to manipulate and control the propagation of light. The light guiding component 2304 may include any suitable waveguide structures designed to confine and guide light along a specified path, allowing it to travel from one point to another with minimal loss and dispersion. Examples of waveguides that may be used as the light guiding component 2304 include planar waveguides, optical fibers, photonic crystal waveguides, and rib waveguides. In some embodiments, the light guiding component 2304 may include a material with a higher refractive index, known as the “core,” surrounded by a material with a lower refractive index, known as the “cladding.” The refractive index contrast between the core and cladding helps guide light within the core by using total internal reflection. Light is trapped within the core due to its reflection at the core-cladding interface. The light guiding component 2304 may support various modes of light propagation, such as single-mode or multimode.

In some embodiments, the photonic device 2300 may include at least one PIC 2306. A PIC 2306 may be a miniaturized and integrated optical device that incorporates photonic components, such as optical modulators, photodetectors, and waveguides, onto a single substrate. In some embodiments, the PIC 2306 may include one or more optical modulators for encoding data onto an optical signal, e.g., onto light generated by the light source 2302. An optical modulator of the PIC 2306 may change certain properties of an optical signal, such as its amplitude, frequency, or phase, in order to encode information onto the signal or to perform various signal processing functions. Examples of optical modulators that may be implemented in the PIC 2306 include electro-optic modulators, Mach-Zehnder Interferometric (MZI) modulators, or microring modulators. In some embodiments, the PIC 2306 may include one or more photodetectors for detecting and measuring the intensity of light or optical radiation across various wavelengths by converting incident light/photons into an electrical signal. Examples of photodetectors that may be implemented in the PIC 2306 include photodiodes, avalanche photodiodes, phototransistors, PIN diodes, CMOS image sensors, photomultiplier tubes, or quantum photodetectors. In some embodiments, the PIC 2306 may include one or more waveguides, e.g., any of the waveguides described with reference to the light guiding component 2304.

In some embodiments, the photonic device 2300 may include at least one optical coupling component 2308. The optical coupling component 2308 may include any suitable structures designed to facilitate efficient transfer of light between different optical devices, e.g., between the light source 2302 and the light guiding component 2304, between the light source 2302 and the PIC 2306, between the light guiding component 2304 and the PIC 2306, or between the light guiding component 2304 or the PIC 2306 and a further transmission line such as a fiber (not shown in FIG. 18) that may be coupled to the photonic device 2300. Examples of optical coupling elements that may be used to implement the optical coupling component 2308 include fiber couplers (e.g., fused fiber couplers or tapered fiber couplers), waveguide couplers, grating couplers, lens couplers, microlens couplers, prism couplers, fiber array couplers, or ball lens couplers. In some embodiment, the optical coupling component 2308 may include one or more optical couplers as described herein.

In some embodiments, the photonic device 2300 may include at least one wavelength splitter/multiplexer 2310, to combine or split multiple optical signals that are carried at different wavelengths. This may be particular advantageous if the photonic device 2300 is used in an optical communication system such as a wavelength division multiplexing (WDM) system or a dense wavelength division multiplexing (DWDM) system, where multiple data channels are transmitted simultaneously over a single optical fiber using different wavelengths of light. In various embodiments, the wavelength splitter/multiplexer 2310 may include a wavelength division multiplexer, a wavelength division demultiplexer, a passive optical add/drop multiplexer, an arrayed waveguide grating, a fused fiber couplers, and interleavers, or an optical filter based device.

In some embodiments, the photonic device 2300 may include at least one polarization splitter/multiplexer 2312, to combine or split multiple optical signals depending on their polarization. Similarly, in some embodiments, the photonic device 2300 may include at least one polarization controlling component 2314, to control polarization of light generated and manipulated in the photonic device 2300. In various embodiments, a polarization splitter/multiplexer 2312 and a polarization controlling component 2314 may include any suitable structure to enable the manipulation and management of polarized light signals, such as birefringent materials, waveguide structures, or specialized coatings that interact differently with different polarization states.

In some embodiments, the photonic device 2300 may include at least one general power splitter/multiplexer 2316, to combine or split multiple optical signals that in a manner that is not dependent on wavelength or polarization. For example, in some embodiments a power splitter/multiplexer 2316 may be used to tap off a small amount of optical power for purposes or power monitoring in the photonic device 2300. Examples of devices that may be used as a power splitter/multiplexer 2316 include directional couplers and multimode interference couplers.

In some embodiments, the photonic device 2300 may include at least one circulator 2318, also referred to as a “directional splitter.” The circulator 2318 may include any suitable device configured to direct light signals to travel in a specific, one-way circular path through its ports. In some embodiments, the circulator 2318 may include magneto-optic materials or other techniques that create a Faraday rotation effect, where the polarization of light is rotated as it passes through the circulator 2318.

In some embodiments, the photonic device 2300 may include at least one mode splitter/multiplexer 2320, to combine or split multiple optical signals based on their guided modes. Examples of devices that may be used as a mode splitter/multiplexer 2320 include directional couplers, multimode interference couplers, tapered waveguide couplers, photonic lanterns, or photonic crystal splitters.

In some embodiments, the photonic device 2300 may include a processing device 2322 (e.g., one or more processing devices). As used herein, the term “processing device” or “processor” may refer to any device or portion of a device that processes electronic data from registers and/or memory to transform that electronic data into other electronic data that may be stored in registers and/or memory. The processing device 2322 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices. In some embodiments, the processing device 2322 may include circuitry to control operation of other components of the photonic device 2300, e.g., to control operation of the PIC 2306.

In some embodiments, the photonic device 2300 may include a memory 2324, which may itself include one or more memory devices such as volatile memory (e.g., DRAM), nonvolatile memory (e.g., read-only memory (ROM)), flash memory, solid state memory, and/or a hard drive. In some embodiments, the memory 2404 may include memory that shares a die with the processing device 2322. This memory may be used as cache memory and may include embedded DRAM (eDRAM) or spin transfer torque magnetic random-access memory (MRAM). In some embodiments, the memory 2324 may store instructions or data for the processing device 2322 to control operation of other components of the photonic device 2300, e.g., to control operation of the PIC 2306.

The following paragraphs provide examples of various ones of the embodiments disclosed herein.

Example 1 provides a photonic integrated circuit (PIC) including an optical channel extending in a first direction; a reflector at an end of the optical channel, the reflector having a surface that is angled relative to the first direction; and a lens over the reflector, where an optical path from the reflector to the lens is perpendicular to the first direction.

Example 2 provides the PIC of example 1 further including a substrate extending across a plane, and the first direction is parallel to the plane of the substrate.

Example 3 provides the PIC of example 1 or 2, where the reflector includes a high-reflection coating along the surface.

Example 4 provides the PIC of example 1 or 2, where the reflector includes a total internal reflection (TIR) reflector along the surface.

Example 5 provides the PIC of any of examples 1-4, where the lens is a convex lens.

Example 6 provides the PIC of any of examples 1-5, where the lens is configured to collimate light travelling through the lens from the reflector.

Example 7 provides the PIC of any of examples 1-6, where the optical channel is in a first layer, the lens is in a second layer, and the first layer is bonded to the second layer.

Example 8 provides the PIC of any of examples 1-7, where, in a cross-section through the reflector, optical channel, and lens, the reflector has a parallelogram shape.

Example 9 provides the PIC of any of examples 1-7, where, in a cross-section through the reflector, optical channel, and lens, the reflector is trapezoidal.

Example 10 provides the PIC of example 9, where the reflector has a second surface opposite the angled surface, and the second surface is perpendicular to the first direction.

Example 11 provides the PIC of example 9, where the reflector has a second surface opposite the angled surface and a top surface between the angled surface and the second surface, and a first angle between angled surface and the top surface is within 10° of a second angle between the second surface and the top surface.

Example 12 provides the PIC of any of examples 1-11, where the reflector includes a reflective material over at least one side of a non-reflective inner material.

Example 13 provides a photonic integrated circuit (PIC) assembly including a first layer including a plurality of optical channels extending in a first direction; a plurality of reflectors arranged at respective ends of the optical channels; and a lens array over the first layer, the lens array including a plurality of lenses arranged over corresponding ones of the plurality of reflectors.

Example 14 provides the PIC assembly of example 13, where an optical path from one of the plurality of reflectors to the corresponding one of the plurality of lenses is perpendicular to the first direction.

Example 15 provides the PIC assembly of example 13 or 14, where a first portion of the plurality of lenses are arranged along a first line, and a second portion of the plurality of lenses are arranged along a second line, the first line parallel to the second line and offset relative to the second line.

Example 16 provides the PIC assembly of any of examples 13-15, where the lenses are convex lenses formed in a layer of silicon.

Example 17 provides an assembly including an array of convex lenses arranged at an input to the assembly, where the convex lenses are arranged in at least two rows; and an array of optical fibers, where an input of one of the optical fibers is arranged at a focal point of one of the array of convex lenses.

Example 18 provides the assembly of example 17, where one of the optical fibers is bent at a 90° angle.

Example 19 provides the assembly of example 17 or 18, further including a vent hole over a bend of the optical fiber, the vent hole extending in a direction of the optical fiber at its input.

Example 20 provides the assembly of any of examples 17-19, where the assembly is detachable from a second component, the second component including a plurality of optical outputs with a second plurality of convex lenses arranged in at least two rows.

Example 21 provides an assembly including a layer of a medium for transmitting optical signals; an array of curved mirrors over the layer, where one of the curved mirrors is configured to deflect a beam that travels through the layer; and an array of optical fibers over a portion of the layer, where each of the optical fibers has an input arranged to receive a deflected beam from a corresponding one of the curved mirrors.

Example 22 provides the assembly of example 21, where the assembly is configured to attach to and detach from a second assembly, the second assembly configured to transmit optical signals.

Example 23 provides the assembly of example 22, where the second assembly includes a plurality of lenses having an arrangement corresponding to the array of curved mirrors.

Example 24 provides the assembly of example 22 or 23, where the optical signals transmitted by the second assembly are expanded beams.

Example 25 provides the assembly of any of examples 21-24, where the array of curved mirrors are configured to receive a beam with a beam dimension of at least 5 μm.

Example 26 provides the assembly of any of examples 21-25, where a beam path of an optical signal through the layer is perpendicular to a direction in which one of the optical fibers extends.

Example 27 provides the assembly of any of examples 21-26, where one of the optical fibers is coupled to the layer of a medium for transmitting optical signals using a v-groove structure.

Example 28 provides the assembly of any of examples 21-27, where the medium for transmitting optical signals is glass.

Example 29 provides the assembly of example 28, where the glass is shaped to provide a curved shape of the curved mirrors.

Example 30 provides the assembly of example 29, where the curved mirrors further include a high-reflection coating applied to the glass.

Example 31 provides an optical structure including a glass layer having a first side and a second side opposite the first side; an array of curved mirrors along the second side of the glass layer, where one of the curved mirrors is configured to deflect a beam that travels in a first direction from the first side of the glass layer to the second side of the glass layer, the deflected beam directed in a second direction perpendicular to the first direction; and an array of grooved structures extending along a third direction perpendicular to the first direction and the second direction, each of the grooved structures corresponding to a respective one of the curved mirrors.

Example 32 provides the optical structure of example 31, where a first portion of the array of curved mirrors are arranged along a first line, and a second portion of the array of curved mirrors are arranged along a second line, the first line parallel to the second line and offset relative to the second line.

Example 33 provides the optical structure of example 32, where a first portion of the array of grooved structures extends in the first direction to a position closer to the first portion of the array of curved mirrors than a second portion of the array of grooved structures, the first portion of grooved structures corresponding to the first portion of the array of curved mirrors, and the second portion of grooved structures corresponding to the second portion of the array of curved mirrors.

Example 34 provides the optical structure of example 33, where each of the second portion of the array of grooved structures is between two of the first portion of the array of grooved structures.

Example 35 provides the optical structure of any of examples 31-34, where the first side of the glass layer is planar at regions directly under the curved mirrors in the array of curved mirrors.

Example 36 provides the optical structure of any of examples 31-35, where the curved mirrors include a high-reflection coating over the second side of the glass layer.

Example 37 provides the optical structure of any of examples 31-36, where one of the array of curved mirrors is configured to receive a beam with a beam dimension of at least 5 μm.

Example 38 provides an optical interconnect including a transmitting assembly including an optical channel extending in a first direction; a reflector at an end of the optical channel, the reflector having a surface that is angled relative to the first direction; and a lens over the reflector, where an optical path from the reflector to the lens is perpendicular to the first direction; and a receiving assembly including a curved mirror configured to deflect a beam from the transmitting assembly; and an optical fiber having an input arranged to receive a deflected beam from the curved mirror, the optical fiber extending parallel to the first direction.

Example 39 provides the optical interconnect of example 38, where the transmitting assembly is detachable from the receiving assembly.

Example 40 provides the optical interconnect of example 38 or 39, where the reflector in the transmitting assembly is configured to expand an optical signal from the optical channel relative to a beam dimension of the optical signal in the optical channel.

Example 41 provides an assembly including a bulk material having a cavity formed at one side of the bulk material; a curved mirror formed within the cavity, the curved mirror having a concave shape; and an optical fiber at least partially surrounded by the bulk material, the optical fiber having an input at the cavity and offset from the curved mirror.

Example 42 provides the assembly of example 41, where the curved mirror is a toric mirror.

Example 43 provides the assembly of example 42, where a first direction extends between the curved mirror and the optical fiber, a second direction is perpendicular to the first direction, and the toric mirror has a greater radius of curvature in the first direction than in the second direction.

Example 44 provides the assembly of any of examples 41-43, where the bulk material is glass, and a curved shape of the curved mirror is etched in the glass.

Example 45 provides the assembly of any of examples 41-43, where the bulk material is a polymer, and a curved shape of the curved mirror is printed in the polymer.

Example 46 provides the assembly of any of examples 41-45, where the optical fiber has a bent portion surrounded by the bulk material.

Example 47 provides the assembly of any of examples 41-46, where the assembly is configured to attach to and detach from a second assembly, the second assembly configured to transmit optical signals.

Example 48 provides the assembly of example 47, where the curved mirror is a first curved mirror, and the second assembly a second mirror configured to reflect a beam received from the first curved mirror, the reflected beam directed towards the input to the optical fiber.

Example 49 provides the assembly of any of examples 41-48, where the assembly includes a plurality of curved mirrors including the curved mirror, and the assembly includes a plurality of optical fibers including the optical fiber.

Example 50 provides the assembly of example 49, where the plurality of curved mirrors are arranged along a first row and along a second row, the first row parallel to and offset from the second row.

Example 51 provides an assembly including an insulating material including a front side and a back side; a curved mirror formed at the front side of the insulating material, the curved mirror arranged to deflect an incoming beam away from the curved mirror and away from the front side of the insulating material; and an optical fiber at least partially surrounded by the insulating material, the optical fiber having an input at the front side of the insulating material and offset from the curved mirror.

Example 52 provides the assembly of example 51, where the front side of the insulating material has a cavity therein, and the curved mirror is within the cavity.

Example 53 provides the assembly of example 51 or 52, where the curved mirror is a toric mirror.

Example 54 provides the assembly of example 53, where a first direction extends between the curved mirror and the optical fiber, a second direction is perpendicular to the first direction, and the toric mirror has a greater radius of curvature in the first direction than in the second direction.

Example 55 provides the assembly of any of examples 51-54, where the assembly includes a plurality of curved mirrors including the curved mirror, and the assembly includes a plurality of optical fibers including the optical fiber.

Example 56 provides the assembly of example 55, where the plurality of curved mirrors are arranged along a first row and along a second row, the first row parallel to and offset from the second row.

Example 57 provides an optical interconnect including a transmitting assembly including an optical channel extending in a first direction; a reflector at an end of the optical channel, the reflector having a surface that is angled relative to the first direction; and a first curved mirror; a receiving assembly including a second curved mirror configured to reflect a beam from the reflector to the first curved mirror; and an optical fiber having an input arranged to receive a reflected beam from the first curved mirror.

Example 58 provides the optical interconnect of example 57, where the first curved mirror and the second curved mirror are toric mirrors.

Example 59 provides the optical interconnect of example 57 or 58, where the optical interconnect is configured to permit an alignment error between the transmitting assembly and the receiving assembly of at least 100 μm with a coupling loss of less than −1 dB.

Example 60 provides the optical interconnect of any of examples 57-59, where the transmitting assembly is detachable from the receiving assembly.

Example 61 provides an assembly including an optical bridge including a first pair of waveguides at a first surface of the optical bridge, the first pair of waveguides arranged at a first pitch at a first portion of the optical bridge and a second pitch at a second portion of the optical bridge, the first pitch greater than the second pitch; a second pair of waveguides arranged over the first pair of waveguides at the first portion of the optical bridge, the second pair of waveguides having the first pitch; and a third pair of waveguides arranged over the first pair of waveguides at the second portion of the optical bridge, the third pair of waveguides having the second pitch.

Example 62 provides the assembly of example 61, where the second pair of waveguides are soft optical waveguides.

Example 63 provides the assembly of example 61 or 62, where the second pair of waveguides have the first pitch at the first portion of the optical bridge, and the second pair of waveguides have a third pitch at a portion not over the optical bridge, the third pitch greater than the first pitch.

Example 64 provides the assembly of any of examples 61-63, where the second pair of waveguides are coupled to a detachable interface, the detachable interface configured to be coupled to an optical fiber.

Example 65 provides the assembly of any of examples 61-64, where the third pair of waveguides are in a photonic integrated circuit (PIC).

Example 66 provides the assembly of any of examples 61-65, where one of the second pair of waveguides is coupled to one of the third pair of waveguides by one of the first pair of waveguides in the optical bridge.

Example 67 provides the assembly of any of examples 61-66, where a distance from one of the first pair of waveguides to one of the second pair of waveguides is no greater than 5 μm.

Example 68 provides the assembly of any of examples 61-67, where a distance from one of the first pair of waveguides to one of the third pair of waveguides is no greater than 5 μm.

Example 69 provides the assembly of any of examples 61-68, where the first pitch is at least five times larger than the second pitch.

Example 70 provides the assembly of any of examples 61-68, where a first component including the second pair of waveguides is bonded to the first portion of the optical bridge, and a second component including the third pair of waveguides is bonded to the second portion of the optical bridge.

Example 71 provides an assembly including an optical bridge including a plurality of surface waveguides formed at a first surface of the optical bridge, the plurality of surface waveguides arranged at a first pitch at a first portion of the optical bridge and tapering to a second pitch at a second portion of the optical bridge, the first pitch greater than the second pitch; and a plurality of soft waveguides over the first portion of the optical bridge, where one of the plurality of soft waveguides is coupled to a corresponding one of the surface waveguides by evanescent coupling.

Example 72 provides the assembly of example 71, where the plurality of soft waveguides have the first pitch at the first portion of the optical bridge, and the plurality of soft waveguides have a third pitch at a portion not over the optical bridge, the third pitch greater than the first pitch.

Example 73 provides the assembly of example 71 or 72, where the second pitch is less than 10 μm.

Example 74 provides the assembly of any of examples 71 to 73, where the first pitch is between 20 μm and 100 μm.

Example 75 provides the assembly of any of examples 71 to 74, where a distance from one of the plurality of soft waveguides to one of the plurality of surface waveguides is no greater than 3 μm.

Example 76 provides the assembly of any of examples 71 to 75, where the plurality of soft waveguides are bonded to the first portion of the optical bridge.

Example 77 provides an assembly including an optical bridge including a first plurality of waveguides; a second plurality of waveguides over a first portion of the optical bridge, where a first waveguide of the first plurality of waveguides is arranged relative to a second waveguide of the second plurality of waveguides for evanescent transmission of an optical signal; and a photonic component over a second portion of the optical bridge, the photonic component including a third plurality of waveguides.

Example 78 provides the assembly of example 77, where the photonic component is a die, and the third plurality of waveguides are silicon waveguides.

Example 79 provides the assembly of example 77 or 78, where the first plurality of waveguides in the optical bridge taper from a first pitch in the first portion of the optical bridge to a second pitch in the second portion of the optical bridge, the first pitch larger than the second pitch.

Example 80 provides the assembly of example 79, where the third plurality of waveguides taper from a third pitch to the first pitch, the third pitch larger than the first pitch.

Example 81 provides an assembly including a first layer; a first plurality of waveguides extending along a surface of the first layer; a second layer over the surface of the first layer; and a second plurality of waveguides within the second layer, where, at a first region of the second layer, each of the second plurality of waveguides is over a respective one of the first plurality of waveguides, and at a second region of the second layer, one of the second plurality of waveguides is over another one of the second plurality of waveguides.

Example 82 provides the assembly of example 81, where the first plurality of waveguides include silicon.

Example 83 provides the assembly of example 81 or 82, where the second layer includes glass.

Example 84 provides the assembly of example 83, where the second plurality of waveguides are formed using laser writing.

Example 85 provides the assembly of any of examples 81-84, where in the first region of the second layer, a first pair of adjacent waveguides have a first pitch, and in the second region of the second layer, a second pair of adjacent waveguides have a second pitch, the second pitch greater than the first pitch.

Example 86 provides the assembly of example 85, where the first pitch is less than 40 μm.

Example 87 provides the assembly of example 85 or 86, where the second pitch is at least 100 μm.

Example 88 provides the assembly of any of examples 81-87, where the second region of the second layer is configured to be detachably coupled to a fiber array.

Example 89 provides the assembly of any of examples 81-88, where the second region of the second layer further includes a reflector for changing a direction of an optical beam transmitted from the second plurality of waveguides.

Example 90 provides the assembly of any of examples 81-89, where, in a cross-section through the second region of the second layer, the second plurality of waveguides are arranged in a two-dimensional matrix.

Example 91 provides an assembly including a plurality of surface waveguides extending along a surface; a plurality of three-dimensional waveguides in a glass medium, each of the plurality of three-dimensional waveguides communicatively coupled to a respective one of the plurality of surface waveguides; and an output from the assembly, the output configured to detachably couple each of the plurality of three-dimensional waveguides to a respective one of a plurality of optical fibers.

Example 92 provides the assembly of example 91, where the output is over the glass medium.

Example 93 provides the assembly of example 92, the assembly further including a mirror between the plurality of three-dimensional waveguides and the output, the mirror configured to deflect an optical signal from each of the plurality of three-dimensional waveguides towards the output.

Example 94 provides the assembly of any of examples 91-93, where the plurality of surface waveguides are silicon waveguides over a silicon layer.

Example 95 provides the assembly of any of examples 91-94, where each of the plurality of three-dimensional waveguides is communicatively coupled to the respective one of the plurality of surface waveguides by evanescent coupling.

Example 96 provides the assembly of example 95, where a distance between one of the plurality of three-dimensional waveguides and the respective one of the plurality of surface waveguides is no greater than 3 μm.

Example 97 provides the assembly of any of examples 91-96, further including a bonding layer between the surface including the plurality of surface waveguides and the glass medium.

Example 98 provides an assembly including a silicon layer; a first plurality of waveguides extending along a surface of the silicon layer; a glass layer over the surface of the silicon layer; and a second plurality of waveguides within the glass layer, where each of the second plurality of waveguides is evanescently coupled to a respective one of the first plurality of waveguides.

Example 99 provides the assembly of example 98, where the evanescent coupling is within a first region of the glass layer, and within a second region of the glass layer, one of the second plurality of waveguides is arranged over another one of the second plurality of waveguides

Example 100 provides the assembly of example 99, where, in the second region of the glass layer, a first portion of the second plurality of waveguides are farther from the silicon layer than a second portion of the second plurality of waveguides.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. An assembly comprising:
an optical bridge comprising a first pair of waveguides at a first surface of the optical bridge, the first pair of waveguides arranged at a first pitch at a first portion of the optical bridge and a second pitch at a second portion of the optical bridge, the first pitch greater than the second pitch;
a second pair of waveguides arranged over the first pair of waveguides at the first portion of the optical bridge, the second pair of waveguides having the first pitch; and
a third pair of waveguides arranged over the first pair of waveguides at the second portion of the optical bridge, the third pair of waveguides having the second pitch.

2. The assembly of claim 1, wherein the second pair of waveguides are soft optical waveguides.

3. The assembly of claim 1, wherein the second pair of waveguides have the first pitch at the first portion of the optical bridge, and the second pair of waveguides have a third pitch at a portion not over the optical bridge, the third pitch greater than the first pitch.

4. The assembly of claim 1, wherein the second pair of waveguides are coupled to a detachable interface, the detachable interface configured to be coupled to an optical fiber.

5. The assembly of claim 1, wherein the third pair of waveguides are in a photonic integrated circuit (PIC).

6. The assembly of claim 1, wherein one of the second pair of waveguides is coupled to one of the third pair of waveguides by one of the first pair of waveguides in the optical bridge.

7. The assembly of claim 1, wherein a distance from one of the first pair of waveguides to one of the second pair of waveguides is no greater than 5 μm.

8. The assembly of claim 1, wherein a distance from one of the first pair of waveguides to one of the third pair of waveguides is no greater than 5 μm.

9. The assembly of claim 1, wherein the first pitch is at least five times larger than the second pitch.

10. The assembly of claim 1, wherein a first component comprising the second pair of waveguides is bonded to the first portion of the optical bridge, and a second component comprising the third pair of waveguides is bonded to the second portion of the optical bridge.

11. An assembly comprising:
an optical bridge comprising a plurality of surface waveguides formed at a first surface of the optical bridge, the plurality of surface waveguides arranged at a first pitch at a first portion of the optical bridge and tapering to a second pitch at a second portion of the optical bridge, the first pitch greater than the second pitch; and
a plurality of soft waveguides over the first portion of the optical bridge, wherein one of the plurality of soft waveguides is coupled to a corresponding one of the surface waveguides by evanescent coupling.

12. The assembly of claim 11, wherein the plurality of soft waveguides have the first pitch at the first portion of the optical bridge, and the plurality of soft waveguides have a third pitch at a portion not over the optical bridge, the third pitch greater than the first pitch.

13. The assembly of claim 11, wherein the second pitch is less than 10 μm.

14. The assembly of claim 11, wherein the first pitch is between 20 μm and 100 μm.

15. The assembly of claim 11, wherein a distance from one of the plurality of soft waveguides to one of the plurality of surface waveguides is no greater than 3 μm.

16. The assembly of claim 11, wherein the plurality of soft waveguides are bonded to the first portion of the optical bridge.

17. An assembly comprising:
an optical bridge comprising a first plurality of waveguides;
a second plurality of waveguides over a first portion of the optical bridge, wherein a first waveguide of the first plurality of waveguides is arranged relative to a second waveguide of the second plurality of waveguides for evanescent transmission of an optical signal; and
a photonic component over a second portion of the optical bridge, the photonic component comprising a third plurality of waveguides.

18. The assembly of claim 17, wherein the photonic component is a die, and the third plurality of waveguides are silicon waveguides.

19. The assembly of claim 17, wherein the first plurality of waveguides in the optical bridge taper from a first pitch in the first portion of the optical bridge to a second pitch in the second portion of the optical bridge, the first pitch larger than the second pitch.

20. The assembly of claim 19, wherein the third plurality of waveguides taper from a third pitch to the first pitch, the third pitch larger than the first pitch.
